(19) United States
(12) Patent Application Publication
(10) Pub. No.: US 2026/0131296 A1
(43) Pub. Date: May 14, 2026

(54) Reactors And Methods For Two-Phase Or Three-Phase Reactions

(71) Applicant: Auburn University, Auburn, AL (US)

(72) Inventors: Bruce J. Tatarchuk, Auburn, AL (US); Felix Mendoza Suarez, Auburn, AL (US)

(21) Appl. No.: 19/384,159

(22) Filed: Nov. 10, 2025

Related U.S. Application Data
(60) Provisional application No. 63/718,927, filed on Nov. 11, 2024.

(51) Int. Cl. B01J 8/02

(52) U.S. Cl. CPC B01J 8/0292; B01J 2208/00017; B01J 2208/00539; B01J 2208/00548; B01J 2208/00884

(57) ABSTRACT

Reactors for two-phase or three-phase reactions using a liquid reactant and a gas reactant and methods of use thereof are described herein. The reactors contain a vessel containing a channel. The channel contains a porous matrix therein. The porous matrix contains pores having different diameters. In the porous matrix, a first population of pores have sufficient diameters to hold a liquid reactant in the pores, and a second population of pore have sufficient diameters to hold a gas reactant in the pores. The first population of pores have diameters that are smaller than the second population of pores. The pores in each of the first and second populations are randomly distributed throughout the matrix or are organized, such that pores in the first population are next to or interspersed amongst pores in the second population and vice versa. The porous matrix may contain catalyst for catalytic multiphase reactions.

### CROSS REFERENCE TO RELATED APPLICATION

This application claims priority to U.S. Provisional Patent Application No. 63/718,927 filed Nov. 11, 2024, the disclosure of which is incorporated herein by reference.

### FIELD OF THE INVENTION

The invention is generally in the field of reactors, particularly reactors for two-phase and three-phase reactions using liquid and gas reactants.

### BACKGROUND OF THE INVENTION

Rapid progress in the development of new materials and new medicines constantly drive the chemical industry to the adoption of ever faster, trustable, and more efficient manufacturing processes, which allow producers to offer their products to society quickly from the moment of their development and to ultimately reach a bigger part of the population at more affordable costs. Historically, batch processing has dominated the manufacturing of high-value chemicals, like fine chemicals and Active Pharmaceutical Ingredients (APIs), due to strict regulation that requires processes to be run repeatedly in exactly the same conditions. Additionally, batch production allows contract manufacturers to have flexibility for multiproduct manufacturing, and verification of quality of each batch within the boundaries of a defined time frame. Nevertheless, batch process safety, maintenance and operation between cycles, and long reaction times per batch due to relatively poor reactor heat and mass transfer properties often slows down or increases the cost of high throughput production.

To elucidate, during a chemical manufacturing process using a slurry batch reactor, a liquid substrate, which contains an organic molecule of interest dissolved in an appropriate solvent, must be pumped into the reactor vessel, followed by the addition of the catalyst as an extrudate or a finer powder. Usually under an inert atmosphere, the reactor contents are slowly brought to reaction temperature by means of external heating/cooling over a reactor jacket or internal serpentine, then the reacting gas is introduced at the operating pressure, and agitation begins to promote sufficient phase contacting for chemical reaction. At the end of the reaction time (1-10 hours, typically), the reaction gas is switched to an inert atmosphere, and the contents of the reactor are brought to a temperature suitable for discharge. At this point, the catalyst powder must be separated by filtration, and the liquid is processed in subsequent steps for purification or extraction of the molecule of interest.

Due to their low surface area-to-volume ratios and liquid phase low thermal conductivities, coupled with mixing inefficiencies attributed to high energy consumption for agitation and complex fluid dynamics, batch reactors exhibit limited heat transfer capabilities. This limitation translates to slow cycle times and poor temperature control, imposing an important safety risk on the operation. This risk is especially daunting when the contents in the reactor provide the basis for a highly exothermic reaction and a potential run-away reaction is possible. Only slow heating of the reaction mixture and conversion of the reactants is possible to the extent to which the heat transfer system can adequate remove the heat of reaction. Additionally, because phase contacting is promoted by agitation and gas bubble size, gas-liquid interfacial surface areas are directly tied to the energy input of the reactor's agitation mechanism up to the physical limits imposed by cavitation. Low gas solubilities within the liquid and limited interfacial surface areas accentuate the reactants mass transfer resistances and ultimately prolong processing times and reduce overall productivity.

Over the last few decades, continuous manufacturing has received attention in the production of fine chemicals and pharmaceuticals. A variety of reactor configurations are employed in multiphase catalytic chemical syntheses employed in the pharmaceutical and fine chemicals industries, each tailored to specific reaction kinetics, heat and mass transfer requirements, and operational conditions. Among these, trickle bed reactors, slurry or packed bubble column reactors, various types of fixed-bed reactors, and a variety of microchannel reactor designs stand out as common choices due to their scalability, ease of operation, and versatility across a wide range of chemical processes. However, flow reactors like trickle bed and bubble column reactors may suffer from lower-than-optimal interfacial surface area for mass transport of gaseous reactants into the liquid medium and onto the catalyst particles, limiting the overall rate of reaction and capping productivity and throughput. Since gas and liquid flow through channels in the openings between the solid catalyst particles, governed solely by fluid dynamics, flow maldistributions can occur, leading to excessive back mixing, zones of poor catalyst wetting, or insufficient gas availability, which also diminishes the total productivity of the reactor and product quality.

The nature of industrial-size reactors like trickle beds and bubble column reactors introduces mass transfer resistances due to the extended distances molecules must traverse for effective chemical reactions. To avoid excessive pressure drops, catalysts are used in millimeter sized pellets that exhibit small outer surface areas and long, deep pores that molecules need to penetrate for adsorption on the catalytic active sites, another factor that limits the actual rates of reaction and the overall catalyst effectiveness factors. Concerning heat transfer in flow reactors, achieving precise temperature control is challenging. Although these exhibit larger outer surface area-to-volume ratios for cooling/heating than their batch counterparts, the small number of contact points between catalyst particles and the inner reactor wall, coupled with the low thermal conductivity of typical catalyst supports, may lead to the formation of hot or cold spots, creating the potential for reaction ignition point sources and thermal runaways in the process.

There is a need for improved reactors, particularly ones that permit multiphase reactions.

Therefore, it is an object of the invention to provide reactors for multiphase reactions.

It is another object of the invention to provide reactors with improved heat exchange efficiency or catalyst efficiency, or a combination thereof.

It is a further object of the invention to provide improved methods for conducting multiphase reactions, particularly two-phase or three-phase reactions using liquid and gas reactants.

### SUMMARY OF THE INVENTION

Reactors for two-phase or three-phase reactions using a liquid reactant and a gas reactant are described herein. The reactors contain a vessel containing a channel. The channel contains a porous matrix therein. The porous matrix contains pores having different diameters. In the porous matrix, a first population of pores have sufficient diameters to hold a liquid reactant in the pores, and a second population of pore have sufficient diameters to hold or transport a gas reactant in the pores. The first populations of pores have diameters that are smaller than the second population of pores. In some forms, the liquid reactant is held in the first population of smaller pores by means of capillary and osmotic forces; while the gas reactant is preferentially held or transported in the second population of larger pores. The pores in each of the first and second populations are randomly distributed throughout the matrix or are organized, such that pores in the first population are next to or interspersed amongst pores in the second population and vice versa. Typically, the pores in the first population and pores in the second population are in close proximity to one another, enhancing contact between the liquid and gas reactants. Optionally, the porous matrix contains catalyst particles entrapped therein and/or coated thereon for catalytic multiphase reactions.

The reactors disclosed herein can efficiently conduct highly energetic two-phase reactions or three-phase reactions, such as three-phase heterogeneous catalytic reactions, for example, hydrogenation, oxidation, and halogenation, which are common in the production of pharmaceuticals and fine chemicals. The porous matrix contained in the channel of the reactor is thermally conductive, with intimate contacting to the interior wall of the reactor vessel, and has a pore distribution that improves the flow of liquid and gas phases through the reactor, allowing for independent movement of liquid and gas reactants. Without being bound to any theories, it is believed that the liquid reactant is retained within the smaller, first population of pores in the porous matrix due to capillary force and surface tension. Further, the distribution of the first and second population of pores in the porous matrix can improve interphase contact between gas, liquid, and catalytic particulates (when present), and provide concomitant heat transfer (such as to a cooling medium external to the reactor vessel) for temperature control, resulting in more efficient, safer (such as by reducing the risk of thermal runaway in highly exothermic reactions like hydrogenations), and high throughput chemical reactions.

The improved reaction efficiency and thermal management capability of the reactors allow transformation from batch to continuous manufacturing, particularly for the fine chemicals and pharmaceuticals industries, offering benefits such as reduced plant footprint, lower operational labor, improved product quality, facile catalyst retention and recovery, and reduced waste generation, compared to traditional batch processes, which are less flexible and efficient. The continuous process achieved using the reactors lead to manufacturing cost savings of up to 75%, compared to batch processes, particularly when catalyst activity maintenance is high, representing a substantial improvement over traditional batch reactors with high operational costs and low duty cycles due to their periodic and batch operational nature. The porous matrix of the reactors can also minimize catalyst and raw material usage, especially in scenarios with high catalyst activity maintenance, leading to cost savings compared to batch processes that require a catalyst change for every batch.

### BRIEF DESCRIPTION OF THE DRAWINGS

FIG. 1a is a schematic of the compression of MFM at reactor packing. FIG. 1b is a graph showing MFM compression function.

FIG. 2a is a graphs of pore size distribution of uncompressed microfibrous mesh (MFM). FIG. 2b is a normalized graphs of pore size distribution of uncompressed MFM.

FIG. 3a is a graph showing pore size distribution of MFM after compression and packing inside the tube. FIG. 3b is a graph showing normalized pore size distribution of MFM after compression and packing inside the tube.

FIG. 4 is a graph showing measured liquid holdup in the reactors during two-phase flow experiments.

FIG. 5 is a graph showing the comparison of pore size distribution vs. capillary pressure in MFM, as described by Washburn equation.

FIG. 6 is a graph showing the comparison of measured pressure drops across different reactor bed types. Liquid flowrate: 36 mL/min.

FIGS. 7a-7c are graphs showing the effect of changing liquid flowrates at fixed gas flowrates on E(t) curves in MFEC reactor. FIG. 7a is with 0 (std)mL/min gas flow. FIG. 7b is with 250 (std)mL/min gas flow. FIG. 7c is with 500 (std)mL/min gas flow.

FIGS. 8a-8c are graphs showing the effect of changing gas flowrates at fixed liquid flowrates on E(t) curves in MFEC reactor. FIG. 8a is with 12 mL/min liquid flow. FIG. 8b is with 24 mL/min liquid flow. FIG. 8c is with 36 mL/min liquid flow.

FIGS. 9a-9b are graphs showing the comparison of E(t) (FIG. 9a) and F(t) (FIG. 9b) curves in different reactors with liquid flowrates of 36 mL/min and a gas flowrate of 250 (std)mL/min.

FIGS. 10a-10b are micrographs of MFEC structures. FIG. 10a shows optical microscope image of copper MFEC with Pd/C particles: copper fibers 17 μm, Pd/C particles 150-185 μm. FIG. 10b shows SEM of copper MFEC with Co/Al2O3 particles; copper fibers 12 μm, Co/Al2O3 particles 149-177 μm.

FIG. 11 is a diagram of the experimental setup.

FIG. 12a is diagram of reactor packing. FIG. 12b is a diagram showing a superior view indicating gas and liquid outlet points, directly in contact with the microfibrous mesh.

FIG. 13 is a schematic showing the reaction scheme for the hydrogenation of 2,4-dinitrotoluene.

FIG. 14 is a graph showing the distribution of nitro species concentrations during a typical experiment. Conditions: T=80 C, P=35 psi, Co_DNT=50 mol/m3 (See Table 4, experiment 3).

FIG. 15 is a graph showing the effect of temperature on the nitro species distributions.

FIG. 16a is a graph showing the XPS spectrum of pure Palladium foil reference.

FIG. 16b is a graph showing the spectrum of filter paper impregnated with the reactor effluents during a typical experiment.

FIGS. 17a-17c are graphs showing the effect of changing liquid flowrates at fixed gas flowrates on E(t) curves in MFM reactor. FIG. 17a is with 0 (std)mL/min gas flow. FIG. 17b is with 250 (std)mL/min gas flow. FIG. 17c is with 500 (std)mL/min gas flow.

FIGS. 18a-18c are graphs showing the effect of changing gas flowrates at fixed liquid flowrates on E(t) curves in MFM reactor. FIG. 8a is with 12 mL/min liquid flow. FIG. 8b is with 24 mL/min liquid flow. FIG. 8c is with 36 mL/min liquid flow.

### DETAILED DESCRIPTION OF THE INVENTION

### I. Reactors

The reactors described herein are particularly suitable for conducting a two-phase or a three-phase reaction using one or more liquid reactants and one or more gas reactants. In some forms, the reactor is a flow chemical reactor. The reactors contain a vessel containing a channel. The channel contains a porous matrix therein.

The porous matrix contained in the channel of the reactor is (i) thermally conductive with good channel/vessel wall contacting that promotes a high wall heat transfer coefficient of the channel, thermal management and overall thermal conductance of the reactor, and (ii) has a pore distribution that improves the flow of liquid and gas phases through the reactor, allowing for independent movement of liquid and gas reactants. Without being bound to any theories, it is believed that the liquid reactant is retained within the smaller, first population of pores in the porous matrix due to capillary force and surface tension. Further, the distribution of the first and second population of pores (e.g., pore diameters and their close proximity to one another) in the porous matrix can improve phase contact and temperature control, resulting in more efficient, safer (such as by reducing the risk of thermal runaway in highly exothermic reactions like hydrogenations), and high throughput chemical reactions.

The porous matrix contains pores having different diameters. When a mixture of one or more liquid reactants and one or more gas reactants flow through the channel, a first population of pores have sufficient diameters to hold a liquid reactant in the pores, and a second population of pore have sufficient diameters to hold a gas reactant in the pores. The first populations of pores have diameters that are smaller than the second population of pores.

The pores in each of the first and second populations are randomly distributed throughout the matrix or are organized, such that pores in the first population are next to or interspersed amongst pores in the second population and vice versa. Typically, the pores in the first population and pores in the second population are in close proximity to one another, allowing the liquid reactant(s) and gas reactant(s) to be in close contact with one another, thereby improving interphase contacting for the reactions.

Optionally, the porous matrix contains catalyst particles entrapped therein and/or coated thereon for catalytic multiphase reactions.

### A. Channel

The channel inside the vessel of the reactor contains a porous matrix therein.

The channel can be in any suitable shape. For example, the channel is in the form of a tube or a monolith. For example, a cross-section of the channel has a circular, square, or rectangular shape. The channel can have a cross-section having any shape, for example, a square, rectangle, rhombus, hexagon, octagon, pentagon, etc. The shape and/or size of the cross-section of the channel can vary over its length. For example, the height or width may taper from a relatively large dimension to a relatively small dimension, or vice versa, over the length of the channel. Optionally, the cross-sectional shape and size of the channel is uniform over its length.

Optionally, the vessel of the reactor contains more than one channel, such as an array of channels, arranged in any suitable fashion. When more than one channel is included in the vessel, the channels can have the same shape and size or different shapes and/or different sizes. The number of channels within the reactor can be determined based on the specific reactions and dimensions of the reactor.

The channel or each channel (when more than one channel is present) can have any suitable internal dimensions. The channel can have any length, depending on the purpose and conditions of the reaction being carried out. Exemplary lengths of the channel are in the range of 0.1 m to 50 m, optionally in the range of 0.1 m to 25 m, 0.1 m to 10 m, 1 m to 50 m, 1 m to 25 m, 1 m to 10 m, or 1 m to 3 m, or in the range of 5 m to 25 m, such as 1 m, 2 m, 3 m, 4 m, 5 m, 6 m, 10 m, 15 m, 20 m, 50 m, etc. The length and width of the channel may be the same or different.

The channel walls can be made of any suitable material(s), such as metals, metal alloys, glasses, or ceramics. Examples of metals and metal alloys that can be used to manufacture the channel walls include, but are not limited to, stainless steel, silver, zinc, copper, aluminum, nickel, iron, titanium, chromium, hastelloy, fecraloy, and acid resistant and corrosion inhibiting metal alloys thereof. Optionally, the channel is formed from a metal alloy, such as stainless steel.

Chemical reactions occurring within the reactor typically take place within the channel(s). The channel can have a flow through design, be periodically opened, or the flow can be variable in flow rate or direction. Typically, the channel(s) is arranged in the vessel to allow laminar flow of fluids and gases (gas product, fluid product, gas reactant, gas product) through the reactor. This laminar flow may be reinforced by the small dimensionality within the pore structure, leading to small Reynold's number laminar flow conditions.

The channel contains a porous matrix packed inside the channel (i.e., the space surrounded by the walls defining the channel). When more than one channel is contained in the porous matrix, each channel may contain a porous matrix or one or more channels (but not all channels) contain a porous matrix.

### 1. Porous Matrix

The porous matrix has highly porous structure, such as characterized by the void space therein. Generally, the void space in the porous matrix is at least about 60%, such as from about 85% to about 99.5%, from about 85% to about 98%, from about 90% to about 98%, for example, about 98% or 99%.

The porous matrix can be packed in the channel in any suitable fashion. For example, the porous matrix contained in the channel is along the axial direction of the channel. The porous matrix can be in any suitable form. For example, the porous matrix is in the form of a mesh or a foam. The porous matrix has an open structure, without an excessive number of closed pores or foam that would otherwise prevent the flow of the gas and liquid along the longitudinal axis of the channel.

The porous matrix contained in the channel maybe thermally conductive that enhances heat transfer from the porous matrix to the channel/vessel wall. The thermal conductivity of the porous matrix and optionally high thermal conductance to a heat exchange medium on the exterior of the vessel, also allows precise temperature control, reducing the risk of thermal runaway in highly exothermic reactions such as hydrogenations, and reducing/preventing hot spots due to limited heat transfer capabilities in traditional batch reactors.

The porous matrix contains pores having different diameters. The pores are distributed in the matrix such that when a mixture of one or more liquid reactants and one or more gas reactants flow through the channel, a first population of pores has sufficient diameters to hold a liquid reactant in the pores, and a second population of pores has sufficient diameters to hold a gas reactant in the pores. The first population of pores has diameters that are smaller than the second population of pores. In some forms, the porosity and pore diameter of the first population of pores wick the liquid (e.g., liquid reactant) in the channel. In some forms, the liquid reactant is preferentially held in the first population of smaller pores by means of capillary and osmotic forces; while the gas reactant is preferentially held or transported in the second population of larger pores.

The pore distribution in the porous matrix allows the liquid and gas reactants to move independently due to capillary force and surface tension of the liquid, which is not found in traditional reactor designs. Without being bound to any theory, it is believed that it takes much larger forces to expel the liquid contained in smaller pores thereby accommodating the gaseous flow into the larger of the pores in the matrix.

The size distribution and close adjacent proximity of the pores in the porous matrix also allows the liquid reactant(s) and gas reactant(s) to be in close contact with one another, thereby improving interphase contacting for the reactions. The improved phase contacting of liquid and gas reactants is particularly useful in three-phase heterogeneous catalytic reactions.

a. Materials

The porous matrix can be formed from any suitable material, as long as the material forms a highly porous structure containing pores of different diameters, provides thermal conductivity and conduction of heat to the interior wall of the vessel, and has chemical compatibility with the reaction that is performed. For example, the porous matrix is formed using a metal, a ceramic, or a polymer, or a combination thereof.

In some forms, the porous matrix is formed from fibers, such as sinter-fused fibers or binder-fused fibers. In some forms, the porous matrix is formed from a compressed assemblage of fibers. When fibers are used to form the porous matrix, the fibers can have a diameter ranging from 1 micrometers to 250 micrometers, from 1 micrometers to 200 micrometers, from 1 micrometers to 100 micrometers, from 1 micrometers to 50 micrometers, from 1 micrometers to 20 micrometers, or from 2 micrometers to 20 micrometers, such as about 10 micrometers or about 20 micrometers. The porous matrix may be formed using fibers of the same diameter or different diameters. Generally, the volumetric loading of the fibers in the matrix is in a range from about 2 vol. % to about 20 vol. %. In preferred forms, the porous matrix is or contains Microfibrous media.

In some forms, the porous matrix is formed using an agglomerated network of solid particles.

i. Microfibrous Media

In some forms, the porous matrix is Microfibrous media. Microfibrous media (also referred to herein as “MFM”) are highly-porous, sintered, nonwoven support structures capable of entrapping a variety of materials in a fixed-fluidized bed configuration.

Microfibrous media can be made of polymer, ceramic, glass, metal, and/or alloy fibers (e.g., microfibers). The material selected for the microfibrous matrix depends on the desired application. Polymeric fibers are typically used for low-cost applications, while ceramic/glass fibers are useful for highly corrosive environments. Metal and alloy microfibers are useful for cases where enhanced heat and/or electrical conductivity are desired. In some forms, the fibers are metallic fibers, such as copper, nickel, aluminum, steel, stainless steel, silver, or gold, or alloys thereof, or combinations thereof.

The fibers can be a mixture of fibers having different diameters, lengths, and/or composition. Optionally the MFM are formed from a mixture of fibers having different diameters. The fibers can have any suitable diameters, although the diameter is typically less than 1000 microns. In some forms, the diameter is from 0.5-200 μm, such as from 4-100 μm. The length of the fibers is typically from about 0.1 to 10 mm, optionally from about 1 to 10 mm, from about 3 to 8 mm, or from about 4 to 8 mm, such as about 5 to 6 mm. In some forms, the length of the fibers is about 1 mm.

In MFM structures, the volumetric loading of the fibers and optionally materials entrapped therein are mostly independent of one another. This allows the relative amounts of each component to be adjusted over a wide range of parameters. In some forms, the amount of the fibers in the MFM is from about 1 vol. % to about 40 vol. %, such as from about 10 vol. % to about 30 vol. % or from about 2 vol. % to about 20 vol. %.

The MFM can be prepared using techniques known in the art, such as wet-lay and sintering processes as disclosed in U.S. Pat. Nos. 5,080,963, 5,080,963, 5,304,330, 6,231,792, 7,501,012, and 8,420,023, which are incorporated herein by reference in their entirety.

The pore sizes of the MFM are generally in the range of 10-500 mesh, typically 50-100 mesh, and optionally 60-90 mesh, depending on the fiber diameter and fiber length and preparation conditions. The void space is at least about 60%, such as from about 85 to about 99.5%. Fiber length can vary; optionally the fibers have lengths in the range of about 0.1 to about 10 mm. The as-prepared media can be processed to reach the aforementioned fiber volumetric fractions.

The MFM can contain multiple layers containing fibers of different diameters and/or different materials depending on materials to be entrapped and/or intended application. The fibers in the multiple layers can be fused together during the sintering step.

In some forms, the MFM further contains carbon fibers, graphite fibers, and/or carbon nanotubes, such as single-walled and/or multiwalled nanotubes. The carbon/graphite fibers can be in the form of wet-lay sheets, bonded threads or yarns, and/or woven sheets. The diameter of the carbon/graphite fibers can vary. In some forms, the diameter of the carbon/graphite fibers is from about 1 nm to about 250 microns, preferably 1 micron or greater, such as from about 1 micron to about 250 microns or from about 1 micron to about 100 microns.

MFM is a good interfacial material for improving heat transfer from chemical reactions to the channel walls and/or vessel walls, particularly highly energetic reactions, such as hydrogenations. MFM are flexible and deformable so that MFM can be deformed to match various surfaces, i.e. the walls of the channel. MFM made of micro-size metal fibers can form multiple contacting points on the surfaces that facilitate heat transfer.

b. Properties

The porous matrix contained in the channel of the reactor (i) is thermally conductive and has high interfacial contact to the interior wall of the channel/vessel that promotes a high interior wall heat transfer coefficient, resulting in good thermal management and temperature control of the reactor, and (ii) has a suitable pore distribution that provides for the concomitant flow of liquid and gas phases through the reactor channel, allowing for independent movement of the liquid and gas reactants.

i. Pore Distribution

The pores in the porous matrix have different diameters, and are generally divided into at least two populations. A first population of pores have sufficient diameters to strongly hold a liquid reactant in the pores, and a second population of pore have sufficient diameters to hold or transport a gas reactant in the pores, when a mixture of one or more liquid reactants and one or more gas reactants flow through the channel.

The first populations of pores have diameters that are smaller than the second population of pores. Without being bound to any theory, it is believed that the liquid reactant is held within the smaller, first population of pores in the porous matrix due to capillary force and surface tension, which nonlinearly increase in strength as the pore size is reduced. As a result, the liquid reactant and gas reactant are held in two different populations of pores, i.e., the liquid reactant in smaller pores and gas reactant in larger pores. This allows for independent control of the movement of the liquid and gas reactants.

The first and second populations of pores can have any suitable diameters, as long as the first population of pores holds a liquid reactant in the pores, and the second population of pore holds a gas reactant in the pores. The pore distribution in the porous matrix can be measured using methods known in the art, such as alcohol bubble-point porosimetry or mercury porosimetry (e.g., Anton Paar QuantaTec).

For example, the porous matrix contains pores having diameters in the range of about 10 micrometers to about 100 micrometers, where a first population of pores having a diameter of less than 40 micrometers, such as from about 10 micrometers to <40 micrometers; and a second population of pores having a diameter of 40 micrometers or more, such as from 40 micrometers to about 100 micrometers, as measured using alcohol bubble-point porosimetry or mercury porosimetry.

For example, the pore distribution in the porous matrix is similar to that of compressed MFM, as described in the Examples below.

The pores in each of the first and second populations are randomly distributed throughout the matrix or are organized, such that pores in the first population are next to or interspersed amongst pores in the second population and vice versa. The distribution of the pores in the porous matrix allows the liquid reactant(s) and gas reactant(s) to be in close contact with one another, thereby allowing for intimate phase contacts throughout the length of the reactor for more efficient reactions.

ii. Liquid Holdup

When a mixture of one or more liquid reactants and one or more gas reactants flow through the channel containing the porous matrix therein, the liquid reactant(s) can be held inside the smaller pores of the matrix for interacting with the gas reactant(s) held in large pores of the matrix. The liquid holdup can be experimentally determined by the weight and/or volume of liquid in the matrix after a sudden stop of a steady liquid flow, such as described in Example 1 below.

The open structure of the porous matrix is capable of holding large volumes of liquid reactant during flow of both liquid and gas (e.g., a relative liquid holdup of at least 40 vol. %, at least 45 vol. %, at least 50 vol. %, or at least 60 vol. %, relative to the total volume of the reactor) inside the reactor, leading to reactors operating at much higher volumetric throughputs compared to a typical packed bed reactor, such as a glass beads packed bed reactor with the same configuration and dimensions (e.g., reactor/channel shape, orientation, etc.) and running under the same conditions (e.g. flowrate, temperature, pressure, etc.). A typical packed bed reactor using millimeter or larger size particulates may hold only 10 vol. % to 20 vol. % liquid, depending on the gas flow rates, due to the relatively large interparticle pore sizes within the packed bed and the ability of the moving gas to sweep the liquid from the bed as a result of reduced surface tension forces. The strong and nonlinear surface tension forces exhibited by the liquid within the smaller pores of the porous matrix allows for tailoring of the relative liquid and gas holdups by adjustment of the pore size distribution along with the gas and liquid flow rates and optionally other operational variables.

The large volume of liquid is in close proximity to, and thus in contact with the gas reactant and optionally catalyst particles, leading to increased reaction rates, since most of the space is available for the reactants and it is not occupied by any solid inert particulates as, for example, in a typical packed bed reactor. For example, as demonstrated in Example 1 below, reactors containing an exemplary MFM in the channel can hold at least 40 vol. % of liquid in the reactor. The amounts of liquid held in the porous matrix can be modified by adjusting the pore size distribution of the matrix.

For example, the liquid reactant holdup in the pores of the porous matrix of the reactor, as indicated by weight and/or volume of the liquid in the porous matrix, is increased by at least 50%, at least 60%, at least 70%, at least 80% more, at least 90%, at least 100%, at least 200%, at least 300%, or at least 400%, compared to the liquid reactant holdup in a typical packed bed reactor, such as a glass beads packed bed reactor, with the same configuration and dimensions (e.g., reactor/channel shape, orientation, etc.) and running under the same conditions (e.g. flowrate, temperature, pressure, etc.). In forms where the porous matrix of the reactor includes catalyst particles, the comparison is made to the liquid reactant holdup in a typical packed bed reactor with the same configuration and dimensions (e.g., reactor/channel shape, orientation, etc.) and running under the same conditions that also contains the same catalyst and the same catalyst loading.

iii. Pressure Drop

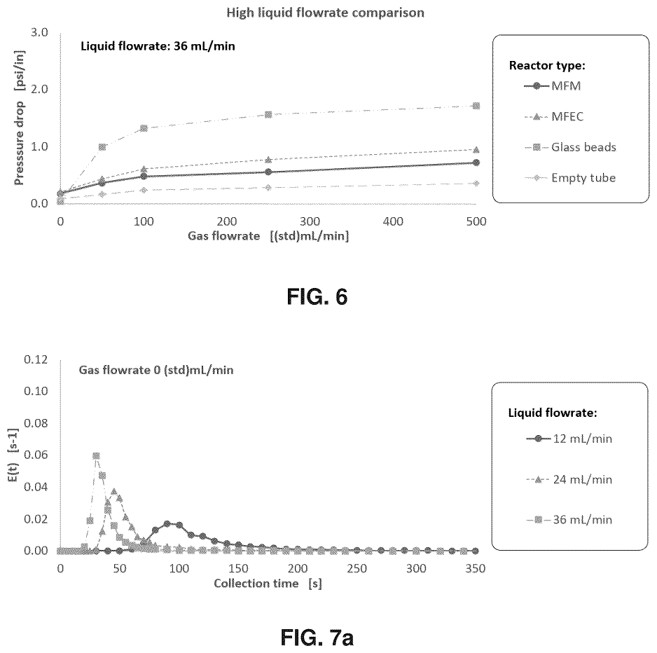

Typically, the reactor shows a low pressure drop from the inlet to the outlet of the channel, such as a pressure drop that is comparable to those of an empty tube, and is at least 20%, at least 30%, at least 40%, or at least 50% lower than those of a glass beads packed bed (see, e.g., FIG. 6).

For example, the pressure drop across the channel of the reactor is less than 2 psi, less than 1.8 psi, less than 1.6 psi, or less than 1 psi such as from about 1 psi to about 1.6 psi. The pressure drop can be measured using methods known in the art, such as steady state flow experiments as described in the Examples below.

iv. Residence Time Distribution

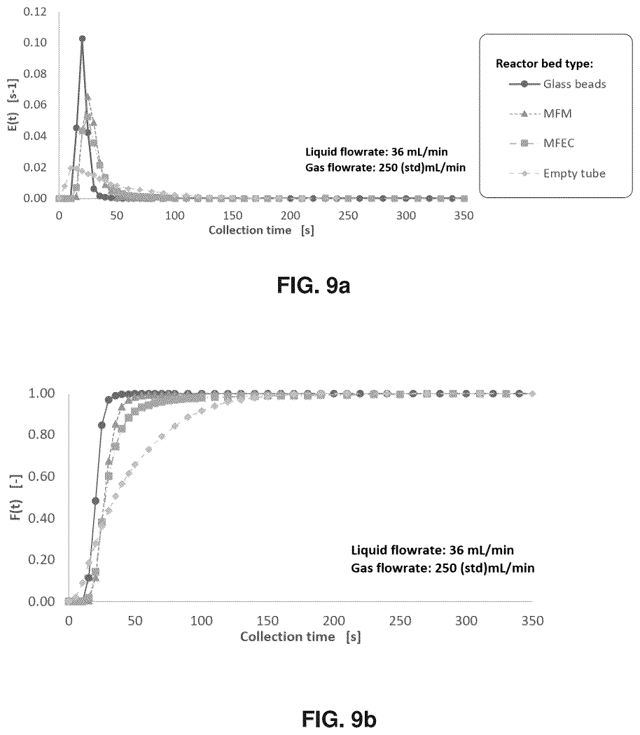

Typically, the residence time distribution (RTD) curves obtained using the reactors described herein show an intermediate behavior compared to those of an empty tube and a glass beads packed bed (see, e.g., FIGS. 9a and 9b). The RTD curves across the reactors can be determined using non-adsorbing trace pulse input experiments, such as described in the Examples.

For example, as described in Example 1, a glass bead packed bed reactor produced an E(t) RTD curve that closely resembles that of an ideal plug flow reactor, exhibiting a low degree of axial dispersion and rapid exit of the liquid tracer pulse. This result is supported by the glass bead packed bed reactor's F(t) curve. Conversely, an empty tube produced broader E(t) and F(t) curves, indicative of significant mixing and longer residence times due to the turbulence generated by the flow of gas as it rises through the liquid, similar to what would be expected from an ideal continuous stirred tank reactor (CSTR). In contrast, the RTD curves of an exemplary reactor containing MFM exhibit an intermediate behavior with some degree of axial dispersion, although closely resemble that of a plug flow reactor. Thus, it is believed, without being bound by theory, that the pores in the porous matrix retain the liquid phase tightly within the matrix due to capillary forces and surface tension, creating preferential pathways for gas and liquid flow in close proximity, and allowing both phases to move independently, producing narrower liquid RTDs with minor effect from the dragging forces of the flowing gas phase.

Further, the RTD curves of the reactor lack broadening of the tracer pulses in the outlet stream with increasing gas flowrate. This result demonstrated that the liquid phase moves through the porous matrix with minimal turbulent mixing, while in close contact with the gaseous phase provided by the close proximity of the pores in the porous matrix.

v. Reynold's Number

Typically, the porous matrix of the reactor has a low Reynold's number (Re), indicative of laminar flow and the absence of turbulent mixing of the gas and liquid phases throughout the length of the reactor. The Reynolds number for the flow of fluids, such as liquids and gases, through of the porous matrix can be calculated based on one or more characteristics of the materials forming the porous matrix and the pore diameters. For example, the Reynolds number for fluid flowing through MFM can be calculated based on the lengths of the fibers, average pore diameter, and optionally the average diameter of catalyst particles entrapped therein.

The porous matrix generally has a Reynolds number less than 1500, less than 1000, less than 500, less than 100, less than 50, less than 10, less than 5, or less than 3, such as 1 or 2. In some forms, the porous matrix has a Reynolds number less than 10, less than 5, or less than 3, such as about 1.

c. Catalyst

When the reaction conducted using the reactors is a catalytic reaction, the porous matrix in the channel of the reactor can contain a catalyst entrapped therein and/or coated thereon. Generally, the volumetric loading of the catalyst in the matrix is in a range from 0.1 vol % to 60 vol %, from 1 vol % to 60 vol %, or from 10 vol % to 60 vol %.

The catalysts can be in the form of particles (e.g. extrudates, pellets, rings, powder, grains, or combinations thereof). For example, the catalysts are in the form of particulates. When the catalysts are in the form of particulates, the particulates can have a diameter ranging from 10 micrometers and 250 micrometers, from 25 micrometers and 250 micrometers, or from 50 micrometers and 250 micrometers. The size of the catalyst can be adjusted to maximize total external surface area, minimize intraparticle diffusional transport distances, or increase its catalytic effectiveness factor, or a combination thereof.

In some forms, the porous matrix containing catalysts entrapped therein are microfibrous entrapped catalysts (MFEC), such as the catalysts described in U.S. Pat. No. 8,420,023 to Tatarchuk, et al., the contents of which are incorporated herein by reference.

The catalyst can be formed using any suitable materials, depending on the specific reactions to be conducted in the reactor. The catalyst contains at least one catalytically active metal or oxide thereof. In some forms, the catalyst includes a catalyst support. In some forms, the catalyst includes at least one promoter. The catalyst can be a catalytically active metal, such as Co, Fe, Ru, Re, or Os, or a combination thereof. The support material can include alumina, zirconia, silica, aluminum fluoride, fluorided alumina, bentonite, ceria, zinc oxide, silica-alumina, silicon carbide, or a molecular sieve, or a combination thereof. The support material can include a refractory oxide. The promoter can include a Group IA, IIA, IIIB or IVB metal or oxide thereof, a lanthanide metal or metal oxide, or an actinide metal or metal oxide. In some forms, the promoter is Li, B, Na, K, Rb, Cs, Mg, Ca, Sr, Ba, Sc, Y, La, Ac, Ti, Zr, La, Ac, Ce, or Th, or an oxide thereof, or a mixture thereof. In some forms, the catalyst can be any catalyst suitable for Hydrogenation reactions.

### B. Inlet and Outlet

Optionally, the reactor contains one or more reactant inlets and one or more product outlets. Typically, the reactant inlet(s) and product outlet(s) are in fluid communication with the channel, such that the fluid and gas reactants flow into the channel via the reactant inlet, and a fluid and/or gas product flow out of the channel and exit the reactor. The inlet and outlet can be positioned at any suitable location in the reactor. Optionally, the inlet is positioned at the bottom of the reactor and the outlet is positioned at the top of the reactor, such that the liquid and gas flow longitudinally through the channel of the reactor.

Optionally, the reactor contains two or more reactant inlets, such that a fluid reactant flows into the channel via the first inlet and the gas reactant flows into the channel via the second inlet. The second inlet can be positioned at any suitable location in the reactor. For example, the first and second inlets are both positioned on the bottom of the reactor and the outlet is positioned on the top of the reactor, to allow the fluid and gas reactant flow longitudinally through the channel in the same direction. Alternatively, the first inlet is positioned on the bottom of the reactor, the first outlet is positioned on the top of the reactor, the second inlet is positioned on the top of the reactor, and a second outlet is positioned on the bottom of the reactor, to allow the fluid and gas reactant flow longitudinally through the channel in opposite directions.

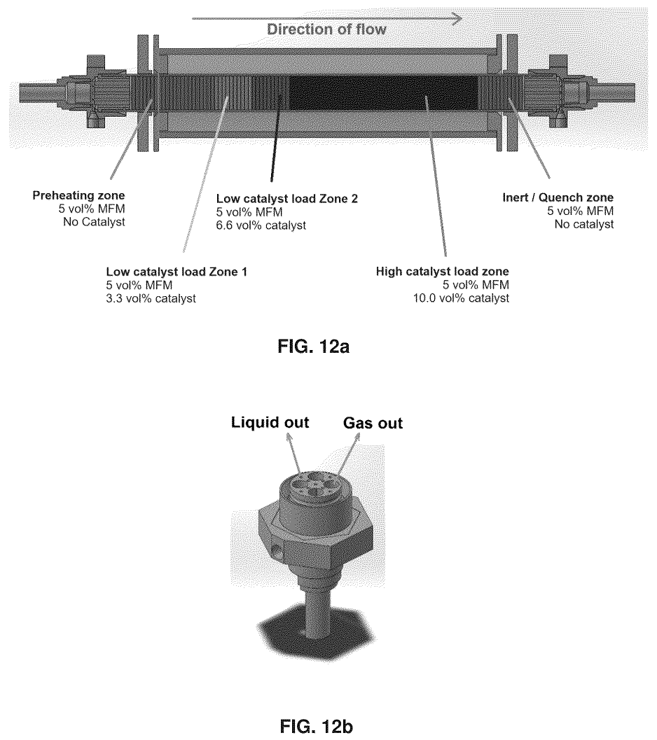

The inlets and outlets can be in any suitable form. For example, each of the inlets and outlet is in the form of or includes a first gas/liquid distributor. The gas/liquid distributors are in fluid communication with the channel and directly in contact with the porous matrix, such as MFM, in the channel of the reactor. The gas/liquid distributor contains openings for the gas and liquid to flow through and into the porous matrix packed inside the channel. Typically, the openings are in two different sizes, i.e., large openings for gas flow and small openings for liquid flow. The large and small openings can be distributed in any suitable fashion in the distributor. For example, as illustrated in FIG. 12b, the gas/liquid distributor contains four large openings for gas flow, where each large opening is surrounded by a plurality of small openings for liquid flow.

### C. Sensors

Optionally, the reactor contains one or more sensors configured to monitor the operation and/or reaction parameters, such as the concentration of a product, flow rate of the gas, flow rate of the liquid, temperature in the reactor, and/or pressure in the reactor.

The sensors can be positioned at any suitable location on/in the reactor, such as on the wall(s) of the channel(s), and/or attached to the inlet and/or outlet of the reactor.

### D. Exemplary Reactor

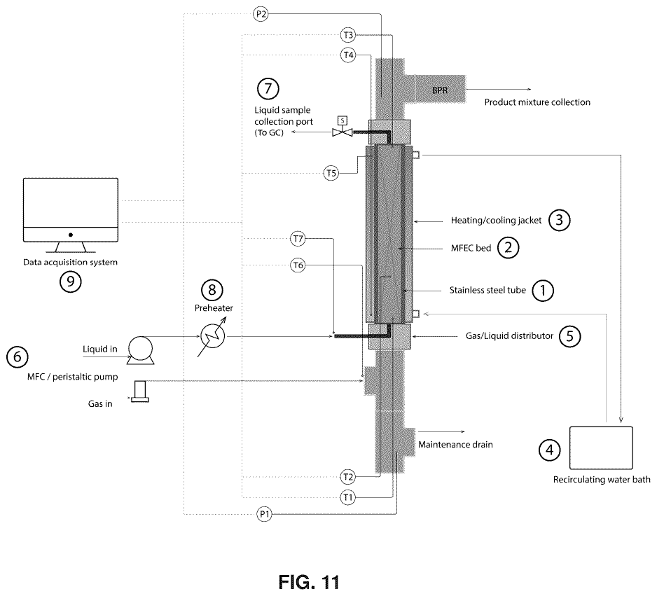

An exemplary reactor 100 is illustrated in FIG. 11. As shown in FIG. 11, reactor 100 includes a vertically oriented tube (1) containing MFM with catalyst entrapped therein (2). The reactor tube (1) is surrounded by a heating/cooling jacket (3) fed by a closed loop recirculating thermal bath (4). A gas/liquid distributor (5) is at the bottom of the reactor tube (1). The gas/liquid distributor (5) is in fluid communication with the reactor tube (1) and is directly in contact with the MFM. The working fluids (i.e., liquid and gas) is directly injected into the MFM via the gas/liquid distributor (5), eliminating any possible liquid return to the bottom part of the assembly (such as via the gas/liquid distributor). Gas and liquid are introduced into the system with the use of mass flow controllers and a peristaltic pump, respectively (6). Another gas-liquid distributor (7), the same type as the one used on the bottom of the tube is located at the top end of the tube, to allow for liquid samples to be collected with the use of a solenoid valve immediately after leaving the MFM without any turbulent mixing to determine the species concentrations. The gas/liquid distributor (5) and (7) each contain a plurality of openings for the gas and liquid to flow through. Typically, the plurality of openings include one or more openings having a first diameter and one or more openings having a second diameter, where the first diameter is larger than the second diameter. For example, the gas/liquid distributor contains large openings for gas flow and small openings for liquid flow. The large and small openings can be distributed in any suitable fashion in the distributor. For example, as illustrated in FIG. 12b, the gas/liquid distributor contains four large openings, each large opening having a plurality of small openings surrounding it. Optionally, before entering the reactor, the liquid can be preheated to a desired temperature for reaction by a tube-in-shell preheater (8). Optionally, several temperature measuring points (T1-T7) can be monitored in real time using one or more sensors, such as type K thermocouples connected to a DATAQ DI-2008 datalogger and to a computer interface (9). The pressures at the entrance and exit points of the porous matrix can also be monitored and recorded using one or more sensors, such as an Omega PX2300-100DI differential pressure transducer connected to the same DATAQ DI-2008 datalogger (P1, P2).

### II. Methods for Using the Reactors

The reactors can be used in a wide range of two-phase and three-phase reactions using fluid and gas reactants, particularly three-phase catalytic heterogenous reactions. Examples of three-phase catalytic heterogenous reactions include, but are not limited to, hydrogenation, nitroreduction, nitrile reduction, ring saturation, protecting group hydrogenolysis, imine reduction, desulfurization, oxidation, partial oxidation, halogenation, oligomerization, oxychlorination, ammoxidation, oxybromination, aromatic substitution, acetoxylations, alkylations, carbonylations, ammonolysis, and dehydrogenation.

The improved reaction efficiency and thermal management capability of the reactors allow transformation from batch to continuous manufacturing, particularly for the fine chemicals and pharmaceuticals industries, offering benefits such as reduced plant footprint, lower operational labor, improved product quality, and reduced waste generation, compared to traditional batch processes, which are less flexible and efficient. The continuous process achieved using the reactors lead to manufacturing cost savings of up to 75%, compared to batch processes, particularly when catalyst activity maintenance is high, representing a substantial improvement over traditional batch reactors with high operational costs. The porous matrix of the reactors can also minimize catalyst and raw material usage, especially in scenarios with high catalyst activity maintenance, leading to cost savings compared to batch processes that require frequent catalyst changes.

For example, as demonstrated in the Examples below, heterogeneous catalytic hydrogenation of 2,4-DNT in an exemplary reactor (i.e., a continuous three-phase fixed bed MFEC reactor) containing small catalyst particles entrapped in a thermally conductive porous metal microfibrous network showed effective phase contacting, residence time, and thermal management under high-throughput conditions, achieving DNT conversions of up to 60% in short residence times, while efficiently managing heat to prevent runaway reactions and allowing fine-tuning of temperature-dependent selectivity toward intermediates.

Generally, the method includes flowing a fluid reactant and a gas reactant through the reactor described herein.

### A. Liquid/Gas Reactants

During step (i), a fluid reactant and a gas reactant flow into the channel containing the porous matrix via one or more reactant inlet(s). The flow of the fluid and gas reactants through the channel can be in any suitable direction, such as vertically, inclined, or horizontally. For example, the flow of the fluid and gas reactants through the channel can be longitudinally along the length of the channel. For example, the flow of the fluid and gas reactants are designed such that the reactants flow due to the wicking effects of the matrix porosity in the presence of gravity, partial gravity, or microgravity. Further, the liquid reactant and gas reactant can flow in a concurrent or countercurrent regime. For example, the liquid reactant flows from the bottom to the top of the reactor longitudinally along the length of the channel, and the gas reactant flows from the top to the bottom of the reactor longitudinally along the length of the channel.

In use, a fluid reactant and a gas reactant enter the inlet(s) and flows in the channel. The fluid reactant may be a solvent or a solvent having one or more chemicals dissolved therein. Once in the channel, the fluid and gas reactants are held in the pores of the porous matrix contained in the channel and in close contact with one another. The gas reactant may be soluble in the liquid reactant or sparing soluble in the liquid reactant. The fluid reactant or the chemicals of the fluid reactant react with the gas reactant, optionally in the presence of a catalyst contained in the porous matrix. A chemical reaction then can occur within the channel, which converts the reactants into one or more products that can be in the form of one or more a liquids and/or one or more gases. Thus, within the channel, the liquid and/or gas are generally a combination of the reactants and products. However, for simplicity, the reactants that enter the inlet of the reactor and inside of the reactor are referred to as liquid reactant and gas reactant. The product that exits the outlet of the reactor is referred to as a liquid product or a gas product.

### B. Velocities

The disclosed methods allow for the independent movement of gas and liquid reactants within the reactor, due to the capillarity and surface tension effects of the porous matrix. As a result, the liquid reactant is held in the population of pores having a smaller diameter (e.g., less than about 40 micrometers), while the gas reactant flows through the population of pores having a larger diameter (e.g., 40 micrometers or more). This allows the relative velocities of the gas and liquid to be changed independently from one another. The capability of independent gas and liquid phase movements achieved using the reactors is not typically found in traditional reactor designs, which often suffer from phase separation and mixing inefficiencies.

For example, in the reactor, the liquid reactant flows at a first velocity and the gas reactant flows at a second velocity. The first velocity is typically different from the second velocity. For example, the flow velocity of the liquid reactant ranges from about 1 mL/min to about 100 mL/min, from about 2 mL/min to about 50 mL/min, from about 5 mL/min to about 20 mL/min, such as about 12 mL/min, about 24 mL/min, or about 36 mL/min; and the flow velocity of the gas reactant ranges from 200 mL/min to about 1200 mL/min, from about 400 mL/min to about 1200 mL/min, or from about 500 mL/min to about 1000 mL/min, such as about 500 mL/min or about 1000 mL/min. By adjusting the respective flow velocities of the liquid and gas reactants, the amounts of liquid and gas held in the porous matrix can be adjusted. Thus, by adjusting the difference in the liquid and gas reactants flow velocities, the desired relative amounts of the liquid and gas reactants can be achieved based on the stoichiometry of a desired chemical reaction.

The flow velocities of the liquid and gas reactants can independently be maintained at a constant value or varied during step (i). For example, the flow velocities of the liquid and gas reactants are held constant during step (i). For example, the flow velocities of both the liquid and gas reactants are varied during step (i). For example, the flow velocity of the liquid reactant is held constant and the flow velocity of the gas reactant is varied during step (i) or vice versa. The flow velocity of the liquid reactant and/or gas reactant can be varied using any suitable methods, such as by pulsing the liquid/gas stream randomly or periodically.

### C. Pressure and Temperature

The pressure and temperature of the fluid and gas reactants in the channel of the reactor depend on the specific reactions carried out. For example, the temperature of the fluid and gas reactants in the channel ranges from about 50° C. to about 100° C., from about 50° C. to about 90° C., or from about 50° C. to about 80° C., such as about 50° C. or about 80° C.

In some forms, the reactor is considered isothermal, at least due to the highly conductive nature of the porous matrix. In some forms, the porous matrix is formed from a highly conductive material, such as a metal, resulting in a high contact area between the conductive material and the catalytic sites where heat is generated. This provides a highly effective mechanism for dissipating and removing heat. This configuration can achieve precise temperature control, allowing for the fine-tuning of selectivity in synthesis processes, which can significantly enhance product quality, yield, and cost-effectiveness.

“Isothermal” means that the biggest difference in temperatures of the gas and liquid phases at the entrance and over the entirety of the catalytic bed is within 6° C., and biggest difference in temperatures of the gas and liquid phases across the reactor's cross section is also within 6° C. For example, during an experiment, the temperatures at the entrance of the catalytic bed and at its end (e.g., catalytic bed top, catalytic bed bottom, jacket inlet, and jacket outlet), is contained within a difference smaller than 1° C. at all times (from 0 to about 90 mins), with the biggest temperature change between the reactor inlet and jacket outlet, which is contained within 6° C. at all times (from 0 to about 90 mins).

In some forms, the pressure of the fluid and gas reactants in the channel ranges from about 20 psi to about 50 psi, from about 20 psi to about 40 psi, or from about 30 psi to about 40 psi, such as 28 psi or 35 psi. Typically, the pressure drop (ΔP) across the reactor is small (e.g., 2 psi or less). For example, under a reactor pressure of about 28 psi, ΔP of the reactor was about 1.5 psi during an experiment of up to 10 hours, up to 8 hours, up to 5 hours, up to 3 hours, or up to 2 hours, such as about 8 hours, about 3 hours, about 2.5 hours, about 1.5 hour, or about 100 min.

The disclosed reactors and methods can be further understood through the following enumerated paragraphs.

Paragraph 1. A reactor suitable for conducting a two-phase or a three-phase reaction, wherein the reactor comprises a vessel comprising a channel with a porous matrix therein,
wherein the porous matrix comprises pores having different diameters,
wherein, when a mixture of a liquid reactant and a gas reactant flows through the channel,
   a first population of pores have sufficient diameters to hold the liquid reactant in the pores,
   a second population of pore have sufficient diameters to hold the gas reactant in the pores, and
wherein the first populations of pores have diameters that are smaller than the second population of pores.

Paragraph 2. The reactor of paragraph 1, wherein the pores in each of the first and second populations are randomly distributed throughout the matrix or are organized such that pores in the first population are next to or interspersed amongst pores in the second population and vice versa.

Paragraph 3: A reactor suitable for conducting a two-phase or a three-phase reaction, wherein the reactor comprises a vessel comprising a channel with a porous matrix therein, wherein the matrix includes different sized pores, and wherein both a liquid and a gas may be passed through the porous matrix in a flowing regime.

Paragraph 4: The reactor of paragraph 3, wherein the matrix comprises pores that wick the liquid.

Paragraph 5: The reactor of paragraph 3 or paragraph 4, wherein the pore size distribution is configured to preferentially hold liquid in the smaller sized pores while the gas preferentially passes through the larger sized pores.

Paragraph 6. The reactor of any one of paragraphs 1-5, wherein the liquid reactant is held in the pores due to surface tension of the liquid and capillary force of the pores.

Paragraph 7. The reactor of any one of paragraphs 1-6, wherein the porous matrix has a Reynolds number (Re) less than 1500, less than 1000, less than 500, less than 100, less than 50, less than 10, less than 5, or less than 3, such as 1 or 2.

Paragraph 8. The reactor of any one of paragraphs 1-7, wherein the porous matrix has a void volume of up to 99.5 vol %.

Paragraph 9. The reactor of any one of paragraphs 1-8, wherein the porous matrix is in the form of a mesh or a foam.

Paragraph 10. The reactor of any one of paragraphs 1-9, wherein the matrix comprises a metal, a ceramic, or a polymer.

Paragraph 11. The reactor of any one of paragraphs 1-10, wherein the porous matrix comprises fibers, such as sinter-fused fibers or binder-fused fibers.

Paragraph 12. The reactor of any one of paragraphs 1-11, wherein the porous matrix comprises a compressed assemblage of fibers.

Paragraph 13. The reactor of any one of paragraphs 1-12, wherein the porous matrix comprises metal microfibrous media.

Paragraph 14. The reactor of any one of paragraphs 11-13, wherein the fibers have a diameter ranging from 2 micrometers to 20 micrometers.

Paragraph 15. The reactor of any one of paragraphs 11-14, wherein the volumetric loading of the fibers in the matrix is in a range from 2 vol % to 20 vol %.

Paragraph 16. The reactor of any one of paragraphs 1-15, wherein the reaction is a catalytic reaction, and wherein the porous matrix further comprises a catalyst entrapped therein and/or coated thereon.

Paragraph 17. The reactor of paragraph 16, wherein the volumetric loading of the catalyst in the matrix is in a range from 0.1 vol % to 60 vol %, from 1 vol % to 60 vol %, or from 10 vol % to 60 vol %.

Paragraph 18. The reactor of paragraph 16 or 17, wherein the catalyst is in the form of particulates, optionally wherein the particulates have a diameter ranging from 10 micrometers and 250 micrometers, from 25 micrometers and 250 micrometers, or from 50 micrometers and 250 micrometers.

Paragraph 19. The reactor of any one of paragraphs 1-18, further comprising a reactant inlet and a product outlet.

Paragraph 20. The reactor of paragraph 19, further comprising a first gas/liquid distributor connected to the reactant inlet and a second gas/liquid distributor connected to the product outlet.

Paragraph 21. The reactor of any one of paragraphs 1-20, further comprising one or more sensors configured to monitor the concentration of a product, flow rate of the gas, flow rate of the liquid, temperature in the reactor, and/or pressure in the reactor.

Paragraph 22. The reactor of any one of paragraph 1-21, wherein the reactor is a flow chemical reactor.

Paragraph 23. A method for conducting a two-phase or a three-phase reaction, comprising (i) flowing a fluid reactant and a gas reactant through the reactor of any one of paragraphs 1-22.

Paragraph 24. The method of paragraph 23, for conducting a three-phase reaction, wherein the reaction is a hydrogenation, nitroreduction, nitrile reduction, ring saturation, protecting group hydrogenolysis, imine reduction, desulfurization, oxidation, partial oxidation, halogenation, oligomerization, oxychlorination, ammoxidation, oxybromination, aromatic substitution, acetoxylations, alkylations, carbonylations, ammonolysis, or dehydrogenation.

Paragraph 25. The method of paragraph 23 or 24, wherein during step (i), the fluid reactant and gas reactant are in close contact with one another.

Paragraph 26. The method of any one of paragraphs 23-25, wherein the gas reactant is soluble or sparing soluble in the liquid reactant.

Paragraph 27. The method of any one of paragraphs 23-26, wherein the fluid reactant flows at a first velocity and the gas reactant flows at a second velocity, wherein the first velocity is different from the second velocity.

Paragraph 28. The method of any one of paragraphs 23-27, wherein the first velocity and/or the second velocity is held constant during step (i).

Paragraph 29. The method of any one of paragraphs 23-27, further comprising adjusting the first velocity and/or the second velocity during step (i).

Paragraph 30. The method of paragraph 29, wherein the flow of the liquid reactant and/or the gas reactant is pulsed randomly or periodically.

### EXAMPLES

### Example 1: Gas-Liquid-Solid Contacting in a Continuous Flow MFEC Reactor

An experimental evaluation of three of the main parameters used to describe the fluid dynamics in a continuous MFEC tubular reactor is disclosed herein including: (i) pressure drop, (ii) gas and liquid holdup and (iii) residence time distribution.

### Materials and Methods

### Test Apparatus:

Tubular reactors of 1.0 in OD (0.91 in ID) and up to 12 in long containing interchangeable beds of 5 in length were used for the present study. The reactors include a vertically oriented stainless-steel tube (1) containing the appropriate bed for each experiment (2) surrounded by a heating/cooling jacket (3) fed by a closed loop recirculating thermal bath (4). Three different reactors were used for comparison in the experiments: an empty tube, a spherical glass beads packed bed, and an MFM bed. The main characteristics of the three reactor beds are summarized in Table 1.

TABLE 1
Reactor Bed Parameters

| | Bed | | Packing | Empty |
|---|---|---|---|---|
| Reactor bed | length | Packing material | volume | volume |
| MFM | 5 in | 17 micron Cu fibers | 10 vol % | 21.5 mL |
| | | with barrier layer | | |
| Glass beads | 5 in | 450-600 μm glass | 74 vol % | 6.2 mL |
| packed bed | | beads | | |
| Empty tube | 5 in | None | — | 23.9 mL |

Inside the tube, to promote uniform initial flow conditions across the entire cross-section of the bed, custom designed gas/liquid distributors (5) inject the working fluids directly in contact with the bed and eliminate any possible pre-mixing. Gas and liquid are introduced into the system with the use of mass flow controllers and a peristaltic pump, respectively (6). The same type of distributor is located at the top end of the bed, to allow for liquid samples to be collected without any turbulent mixing after the liquid leaves the bed structure (7). Before entering the reactor bed, gas and liquid are preheated to the desired experiment's temperature by two independent preheaters (8). Several temperature measuring points (T1-T7) are monitored in real time using type K thermocouples connected to a DATAQ DI-2008 datalogger and to a computer interface (9). The pressures at the entrance and exit points of the bed are also monitored and recorded using an Omega PX2300-100DI differential pressure transducer connected to the same DATAQ DI-2008 datalogger (P1, P2).

### Copper MFM and Reactor Bed Assembly

The copper microfibrous media used for the assembly of the MFM bed was provided by IntraMicron Inc. (Auburn, Alabama). The material was supplied in sheets composed primarily of 17 μm fibers, with an average thickness of 0.3125 inch and weight basis of approximately 100 g/ft², and with a thin barrier layer made of 6 μm fibers that acts both as a support in the lower part of the sheet and a means to retain the catalyst particles during the entrapment process. The MFM sheets were cut to 1.0 inch diameter discs and subsequently packed into the reactor tube in layers.

### Media Compression and Pore Size Distribution

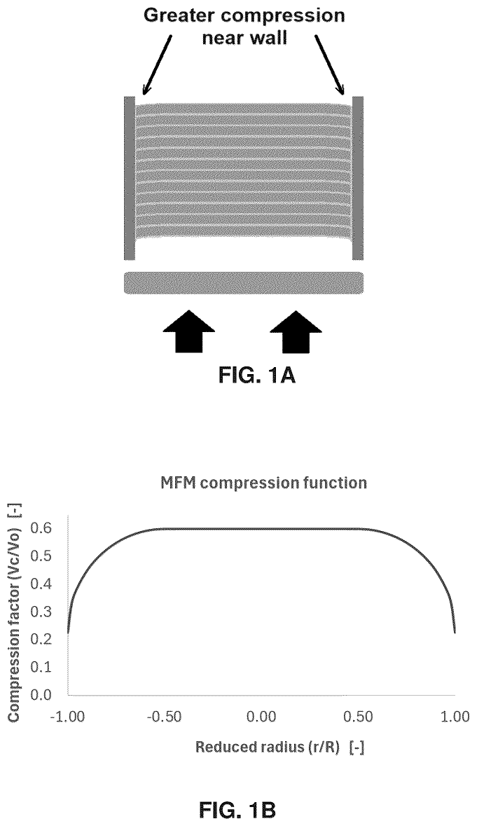

To ensure appropriate wall seal and avoid channeling, the MFM discs are cut the same size as the outer diameter of the reactor tube, and packed by pressure until the desired copper volume fraction is achieved. This packing procedure results in a higher compression factor near the tube walls than at the center line, as shown in FIG. 1a.

This greater compression near the walls of the tube means that the natural pore size distribution of the porous medium changes in a non-uniform way in the radial direction. For design purposes, a volumetric compression factor (V_{compressed}/Vᵢₙᵢₜᵢₐₗ) was considered, where at the inner tube wall the MFM is compressed to 22.5% of its original value, and to 60% at the center line and up to half tube radius, or r/R=0.5 (see FIG. 1b).

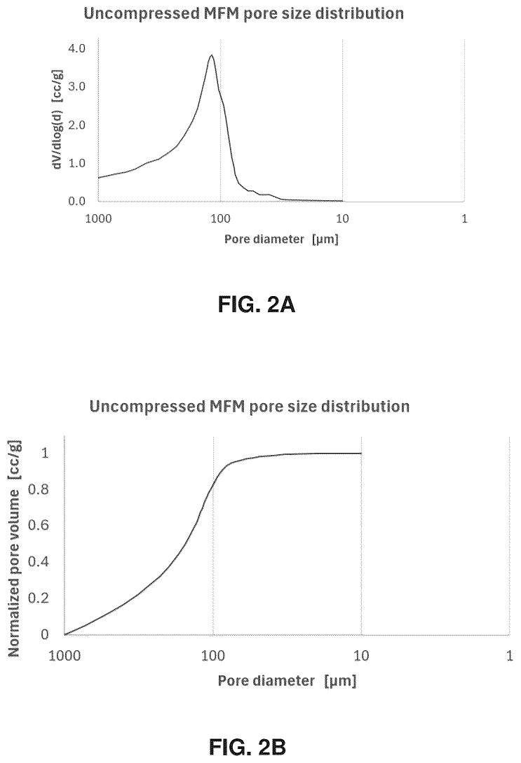

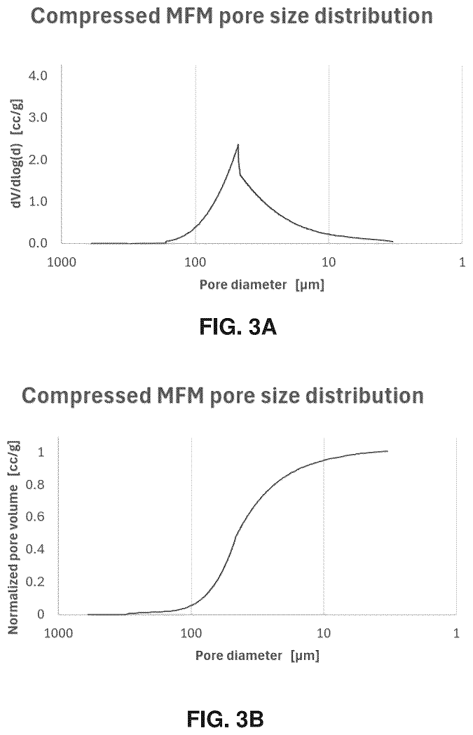

FIG. 2a shows the pore size distribution of the microfibrous mesh as manufactured, measured by mercury porosimetry (Anton Paar QuantaTec) and FIG. 2b is a normalized graphs of pore size distribution of uncompressed MFM. Before compression of any sort, the MFM has a uniform pore size, showing a significant fraction of the pores with a diameter of approximately 185 μm or larger, with a sharp drop in the number of pores of 185 micrometers or less in diameter. After packing the MFM inside the reactor tube, the discs get compressed and the new pore diameter mode is expected to be of between 80 and 50 μm (FIGS. 3a and 3b). The pore size distribution broadens, and it is estimated that the majority of the pores fluctuate between diameters 100 to 10 μm.

### Experimental Procedures

### Liquid Holdup

Liquid holdup was experimentally determined by weight, using reactors assembled. For the measurements, gas and liquid flow across the reactor beds was established at combinations of hydrogen gas flowrates (99.9% pure, AirGas Inc.) between 0 and 1000 (std)mL/min and liquid methanol flowrates (>99% purity, VWR International) of 12, 24 and 36 mL/min. After steady state conditions were achieved, flow was suddenly stopped, and the inlet and outlet reactor valves were closed. These valves were equipped with sanitary clamp connectors that allowed to easily remove the reactor tubes from the setup and place it on a laboratory scale. For comparison, the liquid holdup experiments were performed using a 5 in-long pure copper MFM bed packed at 90 vol % void fraction and a packed bed bubble column reactor made of pyrex glass beads, described in Table 1. all the liquid holdup experiments were performed with non-porous, non-adsorbing materials like the copper MFM and pyrex glass beads, without any catalyst, or catalyst support.

### Pressure Drop

Steady state flow experiments were conducted to determine the pressure drop across the reactor beds. As described above, three 5-in-long reactors, an MFM bed, a glass beads packed bed and an empty tube were used (see Table 1). Different gas flowrates between 0 and 500 (std)mL/min, and three liquid flowrates (12, 24 and 36 mL/min) were selected for the experiments. Each experiment was started by drying the reactor under flow of pure nitrogen (AirGas Inc., 99.9% pure) at 55° C. for 2 hours. With a dry reactor, a flow of hydrogen gas (AirGas Inc., 99.9% purity) was started and stabilized at the desired flowrate to create upward drag inside the bed and avoid any possible liquid return to the bottom of the reactor due to gravity. Next, pure methanol flow (>99% purity, VWR International) was started at the selected flowrate. After stabilizing both gas and liquid flows, indicated by the stabilization of temperature and pressure drop across the bed, the pressure drop was recorded for 10 minutes.

### Determination of RTD

Non-adsorbing trace pulse input experiments were conducted to determine the residence time distribution (RTD) curves across the tubular reactors. Experimental conditions are disclosed in Table 2. Similar to the holdup and pressure drop experiments, a 5 in-long pure copper MFM bed (17 μm diameter fiber, with 6 μm diameter fiber barrier layers) packed at 90 vol % void fraction was set inside the reactor tube for the initial experiments. Three different gas flowrates (0, 250 and 500 (std)mL/min) and three liquid flowrates (12, 24 and 36 mL/min) were used in all combinations. Each experiment was initiated by starting and stabilizing flow of hydrogen gas (AirGas, 99.9% purity) at the desired flowrate to create upward drag inside the bed and avoid any possible liquid return due to gravity. Next, flow of pure methanol (>99% purity, VWR International) was started at the selected flowrate.

TABLE 2
Experimental conditions for RTD experiments

| | Reactor | | |
|---|---|---|---|
| | bed MFM | Glass beads | Empty tube |
| Liquid | | | |
| Flowrate 12 mL/min | | | |
| Linear velocity | 0.12 | 0.41 | 0.11 |
| (cm/s) | | | |
| Theoretical τ (s) | 107.8 | 31.1 | 119.7 |
| Flowrate 24 mL/min | | | |
| Linear velocity | 0.24 | 0.82 | 0.21 |
| (cm/s) | | | |
| Theoretical τ (s) | 53.9 | 15.6 | 59.9 |
| Flowrate 36 mL/min | | | |
| Linear velocity | 0.35 | 1.22 | 0.32 |
| (cm/s) | | | |
| Theoretical τ (s) | 35.9 | 10.4 | 39.9 |
| Gas | | | |
| Flowrate 0 | | | |
| (std)mL/min | | | |
| Linear velocity | 0 | 0 | 0 |
| (cm/s) | | | |
| Theoretical τ (s) | — | — | — |
| Flowrate 250 | | | |
| (std)mL/min | | | |
| Linear velocity | 2.46 | 8.50 | 2.21 |
| (cm/s) | | | |
| Theoretical τ (s) | 5.2 | 1.5 | 5.8 |
| Flowrate 500 | | | |
| (std)mL/min | | | |
| Linear velocity | 4.91 | 17.00 | 4.42 |
| (cm/s) | | | |
| Theoretical τ (s) | 2.6 | 0.7 | 2.9 |
| Flowrate 1000 | | | |
| (std)mL/min | | | |
| Linear velocity | 9.82 | 34.00 | 8.84 |
| (cm/s) | | | |
| Theoretical τ (s) | 1.3 | 0.4 | 1.5 |

After stabilization of both gas and liquid flows, indicated by stabilization of temperature and pressure drop across the bed, a pulse of tracer (concentrated DAT solution (737 mol/m3 2,4-diaminotoluene, >98.0% purity, TCI America, in methanol, >99% purity, VWR International) was injected in the liquid line at the inlet of the reactor at time t₀ with the aid of a six-way switching valve and a calibrated-volume injection loop. Liquid samples of the reactor effluent stream were repeatedly collected and timed intervals and the tracer concentration leaving the reactor was measured by gas chromatography on a (5%-Phenyl)-methylpolysiloxane capillary column connected to an FID detector (carrier gas: Hydrogen).

To compare against ideal reactors on both extremes of the mixing behavior (plug flow and perfectly mixed), two other reactors were assembled and tested using the same procedure described. An empty tube (used to represent an idealized CSTR), and a packed bed bubble column reactor made of glass beads (non-adsorbing) of 450-600 μm diameters, with a mean pore size of 150 μm, to represent a plug flow reactor.

From the data collected, an RTD curve, E(t), is obtained by normalizing the tracer outlet concentration C(t) by the area under the curve C(t) vs. time,

$$E ( t ) = \frac{C ( t )}{{\int }_{0}^{∞} C ( t ) d t} \qquad ( 1 )$$

or numerically,

$$E ( t ) = \frac{C ( t )}{{\sum }_{{t}^{0}}^{{t}_{f}} C ( {t}_{i} ) Δ t} \qquad ( 2 )$$

The cumulative function, F(t), is given by the expression

$$F ( t ) = {\int }_{0}^{∞} E ( t ) d t \qquad ( 3 )$$

or numerically,

$$F ( t ) = {\sum }_{{t}^{0}}^{{t}_{f}} E ( {t}_{i} ) Δ t \qquad ( 4 )$$

A complete summary of the experiment parameters and conditions is given in Tables 1 and 2.

### Results

### Liquid Holdup

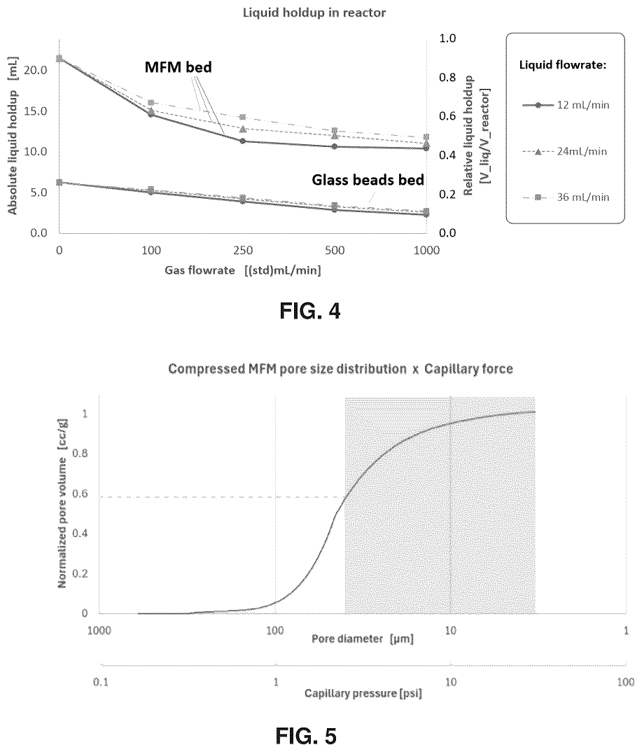

FIG. 4 compares the results of the liquid holdup experiments inside the MFM and glass beads reactors. The first and most notable result is that, because of their high voidage structure, MFM structures are capable of holding much higher volumes of liquid inside the reactor bed (in this case, approximately 4×), which can potentially lead to reactors containing these structures operating at much higher volumetric throughputs. The inherently open structure of the microfibrous mesh, with its high solid surface areas and high voidages, are beneficial for withholding large volumes of gas and liquid in intimate contact with the catalyst particles and increase reaction rates, since most of the space is available for the reactants and it is not occupied by any solid inert particulates as, for example, in a typical packed bed.

As an example, at the highest gas and liquid flowrates utilized in these experiments (1000 (std)mL/min and 36 mL/min, respectively), a packed bed with the same packing fraction as the one used in this work, being a fraction of those solid particles a catalyst totaling to 10 vol % catalyst load, would have a total gas/liquid/catalyst ratio of 1.5/1.1/1, while an MFEC reactor packed with a 10 vol % fraction of copper MFM like the one presented here, and an additional 10 vol % catalyst particles would have an equivalent ratio of gas/liquid/catalyst of 3.6/4.4/1, potentially enabling volumetric productivities up to 4 times higher.

It can also be seen in FIG. 4 that for the glass beads packed bed, at the operating conditions tested, the amount of liquid held inside the bed appears to decrease slowly and almost linearly with increasing gas flowrate, while in the MFM bed, the liquid is rapidly expelled from the reactor at low values of gas flowrate but starts slowly stabilizing at near 50 vol % at higher gas flowrates. These results give an important insight into the structure of MFM beds and how it affects fluid dynamics inside of the reactor.

$$P = \frac{- 2 γ cos θ}{r} \qquad ( 5 )$$

As described by the Washburn equation (Eq. 5), there is a 1/x relationship between the pressure necessary to expel liquid held inside a pore and its radius. The rapid change in liquid holdup with small pressure changes and later approach to an asymptote suggest that the pore size distribution of the bed formed by MFM experiences appreciable changes, where the outer structure gets compressed during the packing of the porous media inside the tube (as shown in the reactor assembly section), as opposed to the more uniform glass beads bed, which shows a linear decrease in liquid content. In return, much higher pressures would be required to force the liquid out of smaller pores, giving it the ability of strongly holding a greater volume of liquid by capillarity even with the dragging forces of the flowing gas, resulting in a potential higher volumetric productivity when employed in reacting conditions.

By combining the pore size distribution for the MFM bed (FIG. 3) and equation 5, it is evident that it would take much larger forces (in the form of the bed's pressure drop) to expel the liquid contained in pores with diameters less than 40 microns, which represents about 40% of the total MFM empty volume, as it can be seen in FIG. 5. To fully empty the reactor from all the liquid entrained within the small pores of the MFM, capillary pressures of about one whole order of magnitude would have to be overcome (represented by the orange region in FIG. 5), at which other factors would potentially come into play, like deformation of the MFM and reactor clogging.

With the ability to independently change the relative amounts of gas and liquid reactants in different regimes, and setting the amount of solid catalyst by design, MFEC reactors could individually optimize the driving forces and contacting needs for different specific reaction kinetics in a unique way that was not available before.

### Pressure Drop

Experimentally measured pressure drops across the reactor beds were collected. As expected, all experiments show an increase in pressure drop with increasing liquid and gas flowrates. Later in FIG. 6 a comparison of the generated pressure drops is presented for all three reactors at the highest liquid flowrate tested (36 mL/min).

The pressure drop generated in the empty tube, is unsurprisingly low, and reaches the maximum value of 4.40 psi/in at the highest gas and liquid flowrates used, since the gas and liquid only need to go through the open space of the tube, and very small energy losses are generated by the turbulent friction of both phases before they exit the reactor bed. Also, as expected, the pressure drop results the highest in the glass beads packed bed, with its minimum and maximum values of 10.6 psi/in and 20.1 psi/in, respectively, at the fastest gas flowrate used. As shown in Table 1, the packed bed has the lowest void fraction of the three reactors used, generating thus the highest friction between both flowing phases and the solid spherical particles.

Of particular interest is the performance of the MFM and MFEC beds, which show remarkably low pressure drops, comparable at low flowrates to those of the empty tube. At the highest liquid flowrate, the pressure drops generated were found to be about 50% lower than those of the packed bed for all gas flowrates (FIG. 6). This result highlights the importance of the open, high-voidage structure of MFEC reactor configurations and the potential hydraulic advantages offered by them, suggesting remarkably low flow resistance and more effective energy usage than other traditional reactors, while achieving high liquid holdup fractions as a consequence of the surface tension forces in the small dimension pores.

### Residence Time Distribution (RTD)

RTD curves were produced by the empty tube and glass beads packed bed reactor at all three different liquid flowrates, in combination with a constant gas flowrate of 250 (std)mL/min, to represent reactors that lean toward the behaviors of a perfectly mixed, and an ideal plug flow reactor. As expected, the E(t) curves show significantly broad tails for the empty tube, following an exponential decay in the tracer concentration, and conversely, the E(t) curves generated with the packed bed reactor resulted appreciably narrower, resembling a sharp pulse coming out from the reactor outlet with a small degree of axial dispersion. In the empty tube, the large open space of the flow channel and the prominent turbulent mixing caused by the bubbling of the gas as it goes through make this reactor example to have a behavior very similar to a CSTR, which results accurate for the purpose of idealized mixed reactor behavior demonstration. Analogously, the small total volume available for flow inside the packed bed formed by the non-porous glass beads, added to the small size of the interparticle channels, promote very small degrees of back mixing in the liquid flow, making this reactor's behavior analogous to an idealized PFR.

Analogously, the F(t) curves are evidently flat for the empty tube, indicating that there is significant mixing and that molecules take substantially long times to leave the reactor. The F(t) curves for the glass beads reactor closely resemble a step function, especially at higher flowrates, the behavior expected for a plug flow reactor.

Along with the experimental curves, the theoretical exponential E(t) curve for a CSTR is shown. It is evident that the experimental measurements for all liquid flowrates follow an exponential decay, similar to the behavior expected in a CSTR. However, comparing the experimental curve for 36 mL/min and the theoretical curve, it is possible to see that the experimental results are slightly shifted to the right. This is an indication of a smaller volume of liquid than what the equation describes. This result is expected, as part of the reactor's volume is occupied by the gas held up inside the tube.

### MFEC RTDs

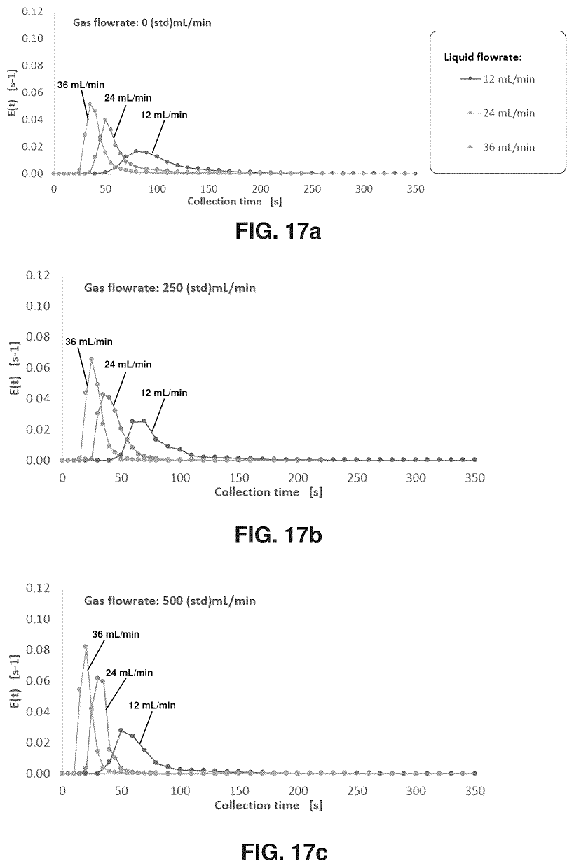

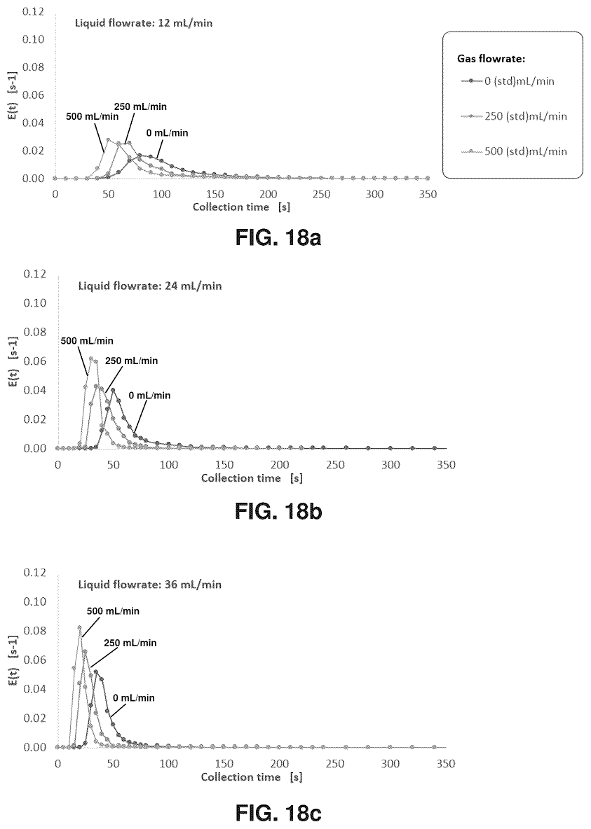

E(t) curves were generated for the MFEC reactor experiments at all selected gas and liquid flowrates. The experiments were performed using an MFM-only bed (without entrapped particles), as well as with a complete MFEC bed (with activated carbon support particles entrapped). RTD curves were produced from the MFM-only bed at different liquid flowrates maintaining a constant gas flowrate in (FIGS. 17a-17c), along with the opposite case (i.e., at different gas flowrates while maintaining a constant liquid flowrate, FIGS. 18a-18c), the effects of changing gas flowrate on the tracer's RTD at constant liquid flowrate.

It is noticeable that the mean residence time for the tracer pulse inside the reactor varies in a higher degree for changes in the liquid flowrate than for changes in the flowrate of gas. This reinforces the notion that the small domains of the MFM pores retain the liquid phase tightly within the bed due to capillary forces and surface tension, creating preferential pathways for gas and liquid flow in close proximity, although allowing both phases to move near-independently, and helping the system to provide narrower liquid RTDs with minor effect from the dragging forces of the flowing gas phase. The observed lack of broadening of the tracer pulses in the outlet stream with increasing gas flowrate also suggests that the liquid phase is able to move through the porous bed of the MFM reactor with minimal turbulent mixing, although in intimate contact with the gaseous phase provided by the close proximity of the channels formed by the connecting MFM small pores.

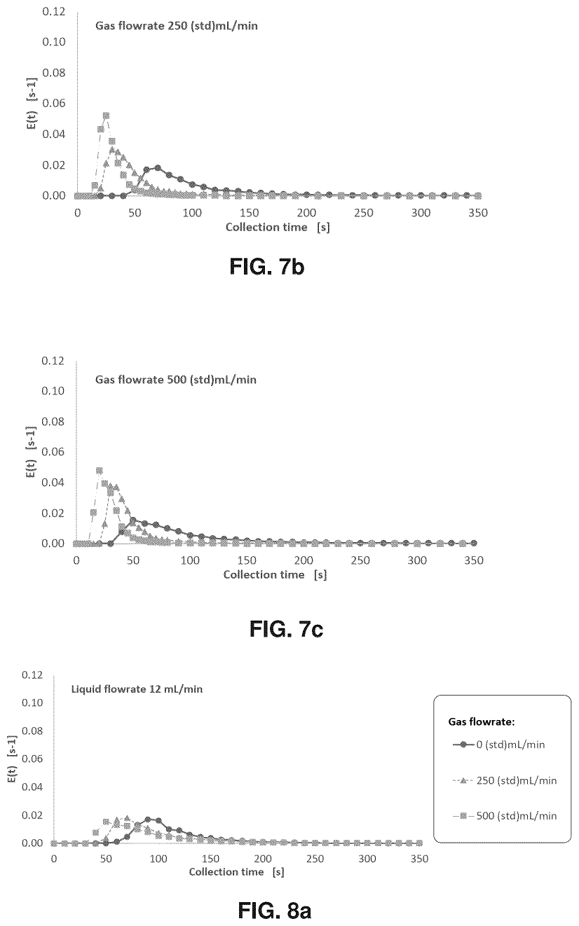

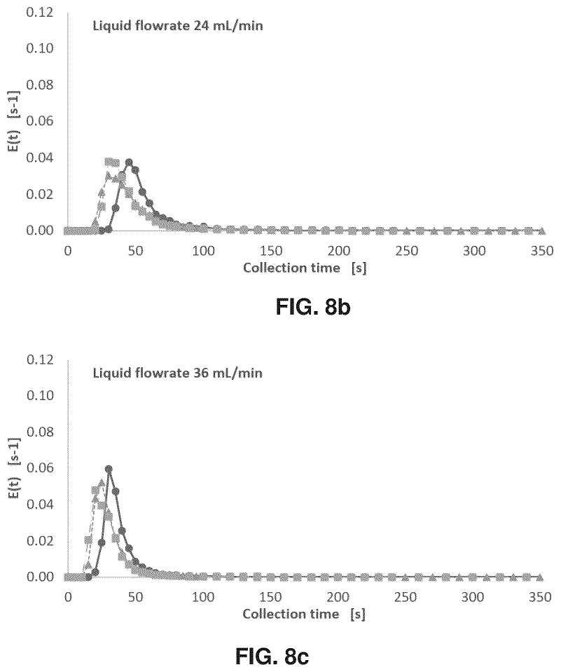

Adding the porous activated carbon particles in the MFM to form a complete MFEC bed introduces a higher degree of axial dispersion, which is expected due to adsorption and desorption effects of the DAT tracer onto the surfaces and pores of the activated carbon. The same behavior towards changes of gas or liquid flowrates is seen, where the mean residence time of the tracer pulse is more dependent on changes of liquid flowrate than of gas (FIGS. 7 and 8). Once again, the notion of surface tension and capillarity playing an important role on strongly retaining the liquid into preferential flow pathways that are in intimate contact (but not strongly mixed) with the gas is observed and reinforced. FIG. 7a is with 0 (std)mL/min. FIG. 7b is with 250 (std)mL/min, and FIG. 7c is with 500 (std)mL/min. FIG. 8 are graphs showing the effect of changing gas flowrates at fixed liquid flowrates on E(t) curves in MFEC reactor. FIG. 8a is with 12 mL/min, FIG. 8b is with 24 mL/min, and FIG. 8c is with 36 mL/min.

### Comparison of Evaluated Reactor Beds

The comparison of residence time distributions (RTDs) across the different reactor beds reveals important insights into their respective behaviors and fluid dynamics (FIG. 9). FIG. 9 are graphs showing the comparison of E(t) (FIG. 9a) and F(t) (FIG. 9b) curves in different reactors The four reactor beds were compared at a liquid flowrate of 36 mL/min and a gas flowrate of 250 (std)mL/min. In the first reactor, the glass beads packed bed reactor, the E(t) RTD curve closely resembles that of an ideal plug flow reactor, exhibiting a low degree of axial dispersion and rapid exit of the liquid tracer pulse. This finding is supported by the reactor's F(t) curve and highlights the reactor's similarity to ideal plug flow behavior. Conversely, the empty tube produced a broader E(t) and F(t) curves, indicative of significant mixing and longer residence times due to the turbulence generated by the flow of gas as it rises through the liquid, similar to what would be expected from an ideal perfectly mixed reactor (CSTR). Notably, the RTD curves of the MFM and MFEC reactor beds exhibit an intermediate behavior with some degree of axial dispersion, although closely resembling that of a plug flow reactor.

Although the available void space inside the MFM and MFEC reactors is almost as large as in an empty tube (90 and 80 vol %, respectively), the distribution of the micron-sized metal fibers across the full cross-sectional area of the reactor bed forms a continuous porous structure with small channels that enable the role of surface tension and capillarity in holding the liquid phase strongly and allowing it to move independently from the gas.

The apparent absence of back mixing in the liquid phase is supported by the occurrence of extremely low Reynolds numbers, which indicate the presence of a laminar flow regime within the small channels. The intra-bed Reynolds number in MFEC structures can be calculated based on the characteristic lengths of the fibers (˜10 μm), particles (˜150 μm) or the expected mean pore diameter (˜80 μm). Because all of these are in the micron scale, calculating the Reynolds number using even the largest of these numbers produces Reynolds numbers close to unity, an indication of local laminar flow and no turbulent mixing.

These two unique characteristics of MFEC structures open a window for potentially tailoring the retention times of the liquid inside the reactor to different needs given by chemical kinetics, while maintaining exceptionally narrow RTDs that can be used to increase yield and selectivity in synthesis processes.

### Conclusions

An experimental evaluation of the fluid dynamic properties of a MFEC fixed bed structured continuous reactor was performed under two-phase flow and compared to a packed bed of common design (see, e.g., Folger H. S. Elements of Chemical Reaction Engineering, Fifth edition; Prentice Hall: Boston, 2016, FIG. 1-14; and Afandizadeh S, Foumeny EA (2001) Design of packed bed reactors: guides to catalyst shape, size, and loading selection. Appl Therm Eng 21:669-682, FIG. 1). To make a practical analysis of the fluid dynamics inside the different reactor beds, liquid holdup, pressure drop, and residence time distributions were measured at different gas and liquid flowrates, with phase velocity ratios varied over two orders of magnitude.

This study demonstrated significant benefits associated with using reactors having a microporous matrix, such as the MFM fiber structure, which retains liquid in the pores in close proximity of the flowing gaseous phase.

First, in two-phase flow through the exemplary reactor, surface tension effects and capillary forces retain the liquid phase strongly in the small domains of the microfibrous bed, segregating it into preferential flow pathways that allow gas and liquid to be moved relatively independent from each other, but in intimate phase contact due to the proximity of the adjacent micron-diameter domains. This characteristic gives the reactor the capability of operating with significantly different phase velocities, without causing turbulent mixing that promotes high degrees of axial dispersion. The microscopic dimensionality of microporous matrix results in low Reynolds number flow within the bed and a near-plug flow behavior, which is desirable for enhanced interphase mass transfer, especially in cases where the gas is sparingly soluble in the liquid phase containing the co-reactant as wetted into the catalyst particle.

Having the ability to independently manipulate the liquid and gas flowrates, multiphase flow can be tailored to specific reaction kinetics by shortening or extending the time the liquid is held inside the reactor, and still feed different amounts of gas at the necessary rates for optimizing the driving forces and contacting requirements in a way heretofore unavailable in traditional reactor designs.

Additionally, due to a substantially higher inherent void fraction, microporous matrices having similar structures to the MFEC described herein are capable of holding up to four times more reacting fluids at equivalent gas and liquid flow rates.

Lastly, the reactor bed exhibits significantly lower pressure drop under two-phase flow compared to the other contacting regimes investigated. This result suggests that the exemplified reactors could be operated in single- or multiphase applications at reduced operating costs due to more efficient energy utilization.

### Example 2: Three-Phase Catalytic Hydrogenation in a Continuous MFEC Reactor

### Materials and Methods

### Microfibrous Entrapped Catalyst Reactors

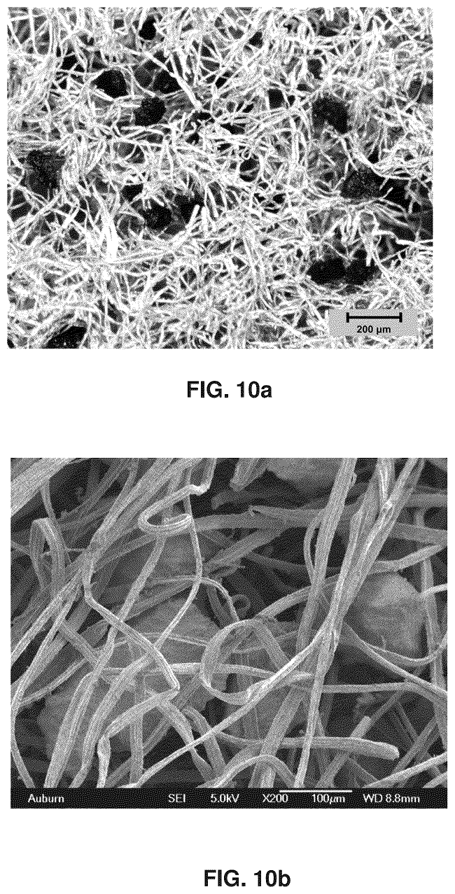

Microfibrous Entrapped Catalyst (MFEC) reactors developed provide a means for performing highly energetic three-phase catalytic reactions in a continuous mode with a design that can be scaled and retains the benefits of microreactor technology by providing uniform, intimate phase contacting and enhanced heat transfer, which allow one to carry out these processes with high yields and precise temperature control. In MFEC reactors, small catalyst particles of 30 to 200 μm in diameter are immobilized inside a sinter-locked metal MFM structure manufactured with metal fibers of 2-20 μm diameter and prepared by a wet lay process. The formation process results in a random and uniform high-voidage, high surface area network that resembles a frozen fluidized bed (see, e.g. FIGS. 10a and 10b). The choice and combination of fiber metal and type of catalyst can be made based on the requirements and chemical compatibility of the application under consideration. FIG. 10a shows optical microscope image of copper MFEC with Pd/C particles: copper fibers 17 μm, Pd/C particles 150-185 μm. FIG. 10b shows SEM of copper MFEC with Co/Al₂O₃ particles; copper fibers 12 μm, Co/Al₂O₃ particles 149-177 μm.

The design of MFEC materials provides an open structure with large void volumes (up to 95 vol %) that results in a low pressure drop and high permeability, and simultaneously, large surface area-to-volume ratios and high thermal conductivity for catalytic reaction and heat transfer. These properties are embedded in a shape-versatile material, capable of being compressed or pleated and integrated in different reactor configurations. Highly open and high-voidage structures are possible and the material may be compressed to almost the tap density of the solid particulates. In this way the catalyst loading, inter particle voidage and heat transfer characteristics of the metal fibers can be optimized in continuum fashion.

The results obtained in a differential, laboratory-scale copper MFEC continuous reactor for the three-phase hydrogenation of 2,4-dinitrotoluene (DNT) over a 5% Pd/C catalyst using methanol as a solvent is disclosed herein. The effects of hydrogen supply, entrapped catalyst load, operating temperature and catalyst life on DNT conversion and products distribution were evaluated. Both transient and steady-state operation were studied. A verification for reactors containing porous matrix, such as MFEC, in three-phase applications was also provided herein.

### Catalyst Preparation and Characterization

Because of the specific required catalyst particles size for entrapment in the copper MFM, all catalysts used were prepared. A 5 wt % Pd/C catalyst was prepared by incipient wetness impregnation of an acid solution of PdCl₂ salt (99.8% purity, Sigma Aldrich) into 150-185 μm activated carbon support particles (OxPure 1230C coconut shell based activated carbon, Puragen). The surface area and pore volume of the activated carbon support was initially measured by nitrogen physisorption at −196° C. using the BET method on an Anton Paar Autosorb IQ adsorption apparatus. Knowing the activated carbon's pore volume, an appropriate volume of 0.8 M PdCl₂ in 0.5 M HCl solution was slowly and thoroughly mixed with the carbon support to achieve a concentration of 5 wt % palladium on the final catalyst. The impregnated support was dried at 120° C. and subsequently reduced under a hydrogen and nitrogen atmosphere at 200° C. for 4 h. The final catalyst was characterized for active metal surface area, crystallite size and dispersion by hydrogen chemisorption and XPS, and compared to samples of a commercial fine powder catalyst (5% Pd/C, 10 μm powder, Sigma-Aldrich). The prepared catalyst method proved to be effective and to produce comparable catalysts to those commercially available. Measured catalyst parameters are summarized in Table 3.

TABLE 3
Catalyst characterization results

| | Prepared catalyst | | Commercial catalyst |
|---|---|---|---|
| Activated carbon (AC) | 935.89 | m²/g | — |
| surface area | | | |
| AC pore volume | 0.494 | cc/g | — |
| AC pore size mode | 1.475 | nm | — |
| Palladium load | 5.02% | | 5.0% |
| Active metal surface area | 1.522 m²/g of | | 0.998 m²/g of |
| | catalyst | | catalyst |
| Dispersion | 6.829% | | 4.480% |
| Crystallite size | 164.034 | Å | 250.061 Å |

### Copper MFM, Catalyst Entrapment and Reactor Assembly

The copper microfibrous media (MFM) into which the prepared catalyst was entrapped, and used for the construction of the catalytic bed was provided by IntraMicron Inc. (Auburn, Alabama). The material was supplied in sheets composed primarily of 17 μm fibers, with an average thickness of 0.3125 inch and weight basis of approximately 100 g/ft², with a thin barrier layer made of 6 μm fibers that acts both as a support in the lower part of the sheet and a means to retain the catalyst particles during the entrapment procedure. The catalyst entrapment process was done by uniformly distributing the desired amount of catalyst onto MFM discs cut to 1.0 in diameter, which were placed in a vacuum vibrating plate rig. With the air flow from the vacuum source and the vibrating movement of the rig, the small catalyst particles fall through the open spaces of the microfibrous mesh, and were trapped and retained within. The bottom barrier layer of finer fibers prevents the catalyst particles from falling through and escaping the sintered metal matrix. After the catalyst was entrapped in the MFM discs, the reactor tube was packed in layers as shown later in FIG. 12a.

### Experimental Setup

A diagram of the experimental setup used is shown in FIG. 11. The reactor includes a vertically oriented 1.0 in OD (0.89 in ID) stainless steel tube (1) containing an MFEC bed (2) made of copper microfibrous mesh (MFM) packed at 5 vol % copper content (95% void) with entrapped 150-185 μm 5% Pd/C catalyst particles packed at 3.3 to 10.0 vol % (a more detailed diagram of the reactor packing is shown in FIG. 12a).

The reactor tube is surrounded by a heating/cooling jacket (3) fed by a closed loop recirculating thermal bath (4). As the tube caps and fittings, to promote uniform initial flow conditions across the entire cross-section of the bed, specially designed gas/liquid distributors (5) inject the working fluids directly in contact with the MFM bed and eliminate any possible liquid return to the bottom part of the assembly (such as via a Gas/Liquid distributor). Optionally, a Gas/Liquid distributor is connected to each of the bottom and top of the reactor, directly in contact with the MFM in the reactor. The Gas/Liquid distributor contains a plurality of openings for the gas and liquid to flow through. Typically, the plurality of openings include one or more openings having a first diameter and one or more openings having a second diameter, where the first diameter is larger than the second diameter. For example, the gas/liquid distributor contains large openings for gas flow and small openings for liquid flow.

The large and small openings can be distributed in any suitable fashion in the distributor. For example, as illustrated in FIG. 12b below, the Gas/Liquid distributor contains four large openings, each large opening having a plurality of small openings surrounding it. Gas and liquid are introduced into the system with the use of mass flow controllers and a peristaltic pump, respectively (6). The same type of gas-liquid distributor used in the bottom is located at the top end of the bed (7), to allow for liquid samples to be collected with the use of a solenoid valve immediately after leaving the bed without any turbulent mixing to determine the true species concentrations. Before entering the reactor, the liquid is preheated to the desired experiment's temperature by a tube-in-shell preheater (8). Several temperature measuring points (T1-T7) are monitored in real time using type K thermocouples connected to a DATAQ DI-2008 datalogger and to a computer interface (9). The pressures at the entrance and exit points of the bed are also monitored and recorded using an Omega PX2300-100DI differential pressure transducer connected to the same DATAQ DI-2008 datalogger (P1, P2).

### Probe Reaction

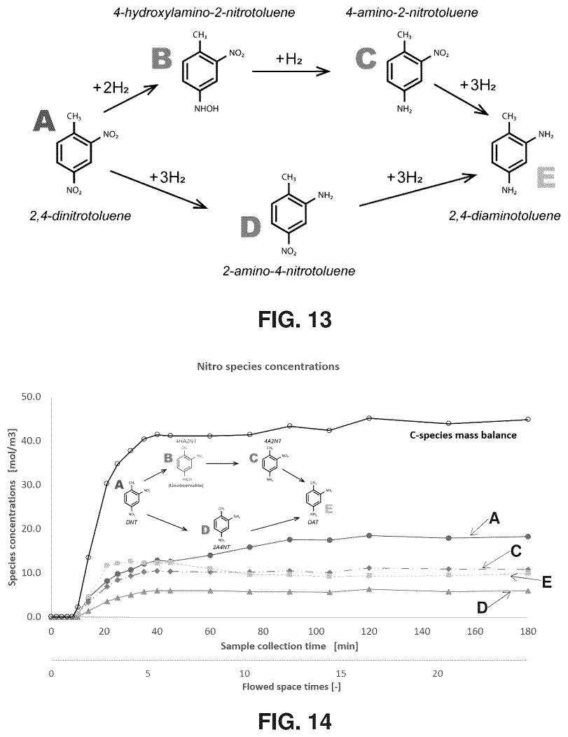

The hydrogenation of 2,4-dinitrotoluene (DNT) was chosen as a probe reaction for the proof of principle of the reactor and used for comparison of the obtained experimental results. Numerous studies on the kinetics of this reaction can be found in literature. For this work, reaction kinetics were modeled to be a complex reaction with competing parallel reactions and several intermediates, as in the model developed by Janssen et al., shown in FIG. 13.

The reaction is known to follow Langmuir-Hinshelwood kinetics, with non-competitive adsorption for hydrogen and the carbonaceous species. The individual reaction rates are given by:

$$\frac{d {C}_{i}}{d t} = {γ}_{cat} {C}_{cat} \sum {υ}_{i j} {k}_{i j} \frac{{K}_{i} {C}_{i}}{1 + {K}_{i} {C}_{i} + {\sum }_{j \neq i} {K}_{j} {C}_{j}} \frac{{{K}_{H} ( \frac{{p}_{{H}_{2}}}{R T} )}^{1 / 2}}{1 + {{K}_{H} ( \frac{{p}_{{H}_{2}}}{R T} )}^{1 / 2}} \qquad ( 6 )$$

for i, j being the nitro compounds shown in FIG. 13 and all other symbols defined as follows:
Cᵢ Concentration of species i [mol/m³]
γ_{cat} Catalyst activity function [-]
C_{cat} Catalyst concentration in reactor [kg/m³]
υᵢⱼ Stoichiometric coefficient for species i in reaction i→j [-]
kᵢⱼ Rate constant for reaction i→j [mol/m³·s]
Kᵢ Adsorption constant for species i [m³/mol]
p_{H}_{₂} Hydrogen pressure [atm]
K_{H} Adsorption and dissolution combined constant for hydrogen [m^{3/2}/mol^{1/2}]
R Universal gas constant [m³·atm/mol·K]
T System temperature [K]

Using the general rate equation given by Eq. 6, a lumped kinetics system can be derived for all species to describe the evolution of the concentrations profile in batch mode:

$$\frac{d {C}_{A}}{d t} = {γ}_{cat} {C}_{cat} ( - {k}_{A B} - {k}_{A D} ) \frac{{K}_{A} {C}_{A}}{1 + {K}_{A} {C}_{A} + {\sum }_{j \neq A} {K}_{j} {C}_{j}} \frac{{{K}_{H}^{′} ( \frac{{p}_{{H}_{2}}}{R T} )}^{1 / 2}}{1 + {{K}_{H}^{′} ( \frac{{p}_{{H}_{2}}}{R T} )}^{1 / 2}} \qquad ( 7 )$$

$$\frac{d {C}_{B}}{d t} = {γ}_{cat} {C}_{cat} ( {k}_{A B} - {k}_{B C} ) \frac{{K}_{B} {C}_{B}}{1 + {\sum }_{A}^{E} {K}_{j} {C}_{j}} \frac{{{K}_{H}^{′} ( \frac{{p}_{{H}_{2}}}{R T} )}^{1 / 2}}{1 + {{K}_{H}^{′} ( \frac{{p}_{{H}_{2}}}{R T} )}^{1 / 2}} \qquad ( 8 )$$

$$\frac{d {C}_{C}}{d t} = {γ}_{cat} {C}_{cat} ( {k}_{B C} - {k}_{C E} ) \frac{{K}_{C} {C}_{C}}{1 + {\sum }_{A}^{E} {K}_{j} {C}_{j}} \frac{{{K}_{H}^{′} ( \frac{{p}_{{H}_{2}}}{R T} )}^{1 / 2}}{1 + {{K}_{H}^{′} ( \frac{{p}_{{H}_{2}}}{R T} )}^{1 / 2}} \qquad ( 9 )$$

$$\frac{d {C}_{D}}{d t} = {γ}_{cat} {C}_{cat} ( {k}_{A D} - {k}_{D E} ) \frac{{K}_{D} {C}_{D}}{1 + {\sum }_{A}^{E} {K}_{j} {C}_{j}} \frac{{{K}_{H}^{′} ( \frac{{p}_{{H}_{2}}}{R T} )}^{1 / 2}}{1 + {{K}_{H}^{′} ( \frac{{p}_{{H}_{2}}}{R T} )}^{1 / 2}} \qquad ( 10 )$$

$${C}_{E} = 1 - ( {C}_{A} + {C}_{B} + {C}_{C} + {C}_{D} ) \qquad ( 11 )$$

With exception of the catalytic activity function and the hydrogen combined adsorption constant, all model parameters used were previously estimated by Janssen et al., Catalytic activity was considered constant (γ_{cat}=1) for the numerical calculations of the lumped kinetics system, as well as a combined hydrogen adsorption constant of

$${K}_{H}^{′} = 0.05 \times {K}_{H}$$

to account for hydrogen mass transfer resistances found in the practical system operated at low pressures.

### Experimental Procedures

At the beginning of every experiment run, the reactor jacket and liquid preheater were taken to the set temperature in order to reduce the system's stabilization time. A typical experiment would begin by starting the flow of hydrogen gas (99.9% pure, AirGas Inc.) at the desired flowrate and subsequently starting liquid flow with pure solvent (Methanol>99% purity, VWR International). The reactor pressure was set with the help of a back pressure regulator. Once all temperatures, pressure, and pressure drop had stabilized and remained at constant values for 15 minutes, the liquid flow was switched to DNT solution (2,4-dinitrotoluene, >98.0% purity, TCI America, in methanol, >99% purity, VWR International) and sufficient time was allowed for the solution to go through the preheater and reach the entrance point of the bed before collecting the first sample, which usually took 15 minutes. At this point, the collection of 250 μL liquid samples started at regular intervals with the use of a solenoid valve from the sample collection port at the top of the reactor (7, in FIG. 11). All liquid samples were analyzed by gas chromatography on a (5%-Phenyl)-methylpolysiloxane capillary column connected to an FID detector (carrier gas: Hydrogen) to determine the species concentrations. At the end of each experiment, the gas flow was reduced to 10% of its operating value, liquid was switched back to pure solvent and the reactor bed was washed with a minimum of 5 reactor volumes of pure methanol. Depending on the plan of experiments, the reactor would be either dried and left overnight under a nitrogen atmosphere, or left flooded in pure methanol to assess activity maintenance in the subsequent experiments. A summary of all experimental conditions is provided below and specified in Table 4 for each individual experiment: Reaction temperatures: 50 and 80° C.; Reactor pressures: 28 and 35 psi; Feed DNT concentrations: 50 and 200 mol/m³; Liquid flowrate: 12 mL/min (estimated residence time: 245-252 s, depending on gas flowrate*); Gas flowrates: 500 and 1000 (std)mL/min; and Phase velocity ratios v_{g}/vₗ: 41.7 and 83.3. Two phase flow through MFEC reactors with these selected gas and liquid flowrates (methanol and hydrogen) results in an average liquid holdup of 45 vol %.

### Results

During the evaluation of the MFEC reactor, the following considerations were taken into account:

The reactor was considered to be isobaric. The pressure drop (ΔP) of the reactor was small (e.g., 2 psi or less) in comparison to the operating pressure for all performed experiments. For example, under a reactor pressure of about 28 psi, ΔP of the reactor was about 1 psi during an experiment of about 100 min.

Because of the highly conductive nature of the MFM, and with the help of the packed preheating section of the bed (see FIG. 12a), the reactor was considered isothermal. Analysis of the temperature profile inside of the reactor during a typical experiment, comparing the temperatures at the entrance of the catalytic bed and at its end (e.g., catalytic bed top, catalytic bed bottom, jacket inlet, and jacket outlet), which were contained within a difference smaller than 1° C. at all times (from 0 to about 90 mins) was conducted. The biggest temperature change was between the reactor inlet and jacket outlet, which were contained within 6° C. at all times (from 0 to about 90 mins).

The temperatures of the gas and liquid phases were also considered to be equal at the entrance and over the entirety of the catalytic bed. Temperature was also considered uniform across the reactor's cross section.

By comparison to previous literature, the gas and liquid mass velocities used indicated that the reactor was operated under a reflow regime which in a typical packed bed reactor would be vertical bubble flow. However, this was only used as a reference starting point for the design of the experimental operating conditions. The fluid dynamics in MFEC reactors were different than in typical packed beds, since the small dimensions of the fibrous MFM make capillary and surface tension forces govern the flow regimes inside the catalytic bed.

### Operating Parameters and Summary of Results

Table 4 shows a summary of the experimental conditions of all runs. Table 5 shows a summary of all experimental results.

TABLE 4
Operating parameters for all experimental runs.

| | T | P | υl | υg | C_{DNT}⁰ | Cat_load | |
|---|---|---|---|---|---|---|---|
| Run | [° C.] | [psi] | [mL/min] | [(std)mL/min] | [mol/m³] | [kg/m³] | Cat_state |
| 1 | 50 | 28 | 12 | 500 | 50 | 10 | New |
| 2 | 50 | 28 | 12 | 500 | 50 | 10 | Used |
| 3 | 80 | 35 | 12 | 500 | 50 | 10 | New |
| 4 | 80 | 35 | 12 | 500 | 50 | 10 | Used |
| 5 | 50 | 28 | 12 | 1000 | 50 | 10 | New |
| 6 | 50 | 28 | 12 | 1000 | 50 | 10 | Used |
| 7 | 50 | 28 | 12 | 1000 | 50 | 10 | Regenerated |
| 8 | 50 | 28 | 12 | 1000 | 200 | 5** | New |
| 9 | 50 | 28 | 12 | 1000 | 200 | 10 | New |
| 10 | 50 | 28 | 12 | 1000 | 50 | 10 | New |

**Catalyst concentration changed

TABLE 5
Experimental results.

| | Duration | T̅₁̅ | T̅₂̅ | T̅₃̅ | Δ̅P̅ | c̅_̅{̅D̅N̅T̅}̅ | c̅_̅{̅2̅A̅4̅N̅T̅}̅ | c̅_̅{̅4̅A̅2̅N̅T̅}̅ | c̅_̅{̅D̅A̅T̅}̅ | ζ̅_̅{̅D̅N̅T̅}̅ |
|---|---|---|---|---|---|---|---|---|---|---|
| Run | [min] | [° C.] | [° C.] | [° C.] | [psi] | [—] | [—] | [—] | [—] | [—] |
| 1 | 150 | 47.43 | 51.44 | 51.54 | 1.37 | 0.763 | 0.057 | 0.067 | 0.078 | 0.237 |
| 2 | 90 | 47.63 | 51.69 | 51.86 | 1.31 | 0.821 | 0.041 | 0.043 | 0.044 | 0.179 |
| 3 | 180 | 73.28 | 79.72 | 79.84 | 1.27 | 0.359 | 0.117 | 0.213 | 0.190 | 0.641 |
| 4 | 90 | 73.08 | 79.96 | 80.13 | 1.23 | 0.414 | 0.113 | 0.206 | 0.174 | 0.586 |
| 5 | 180 | 46.32 | 51.44 | 51.68 | 1.58 | 0.614 | 0.139 | 0.112 | 0.098 | 0.386 |
| 6 | 90 | 46.00 | 51.22 | 51.32 | 1.56 | 0.709 | 0.097 | 0.083 | 0.097 | 0.291 |
| 7 | 90 | 45.45 | 50.26 | 50.41 | 1.64 | 0.681 | 0.098 | 0.097 | 0.097 | 0.319 |
| 8 | 180 | 44.27 | 49.63 | 49.79 | 1.61 | 0.899 | 0.027 | 0.038 | 0.005 | 0.101 |
| 9 | 180 | 44.30 | 50.27 | 50.36 | 1.57 | 0.801 | 0.044 | 0.055 | 0.021 | 0.199 |
| 10 | 8 hours | 44.69 | 51.40 | 51.52 | 1.61 | 0.652 | 0.122 | 0.102 | 0.095 | 0.348 |

Where

$$\overline{{c}_{ι}} = \frac{{\overline{c}}_{ι}}{{c}_{D N T}^{0}}$$

are the averaged reduced concentrations of species i in the system in steady state and ζ̅_̅{̅D̅N̅T̅}̅ is the total conversion of DNT.

### Normal Operation of the Reactor

FIG. 14 shows the distribution of concentrations obtained for the duration of a typical experiment. Because the startup of the reactor operation showed stabilizing the gas and liquid flows across the bed before introducing the reactive DNT, the liquid introduced contained only the methanol solvent. Once gas and liquid were stabilized (indicated by stabilization of temperatures and pressure), the methanol stream was switched to the DNT solution, and the reaction started. After approximately 10 reactor volumes had flowed, the liquid contained in the reactor was assumed to be uniformly saturated with DNT at its maximum concentration, indicated by the mass balance curve on all the nitro species. Because hydrogen was flowing in contact with the solid catalyst since the start of operation, a part of the DNT was converted immediately to the subsequent species, even when the whole reactor was not yet saturated with DNT at its maximum or steady state concentration.

As shown in Table 4, all the experiments, except for runs 3 and 4, were performed at the same pressure of 28 psi (approx. 2 atm). The intention behind this was to perform all experiments at the lowest possible pressure, with just a minor increase above ambient pressure for sample collection using the injection system operated with solenoid valve 7 (see reactor diagram). Runs 3 and 4 were performed at 35 psi to maintain the methanol solvent as a liquid, given the slightly elevated temperature of 80° C. All experiments were performed at the same liquid flowrate, to evaluate the influence of other variables on the reaction's operation, like gas flowrate, temperature and state of the catalyst.

The reactor was considered to have a uniform temperature radial profile, with practically no temperature difference between the reactor wall and its centerline. This assumption was supported by the realization that the temperature of the fluid in the outlet of the heating jacket remains within 0.5° C. of difference to the temperature in the centerline of the reactor bed's outlet, which also showed that virtually all the heat generated in the reaction was successfully removed, eliminating the possibility of a thermal runaway under the experiments' conditions.

### Distribution of Species Concentrations

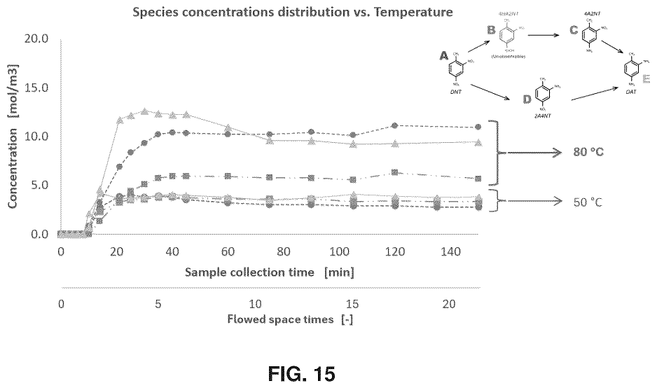

FIG. 15 shows the difference in the obtained species concentrations in two experiments at different operating temperatures (runs 1 and 3, Table 4). While all other variables were kept constant, comparison of these two experiments demonstrated the sensitivity of the hydrogenation reaction of DNT in terms of its selectivity toward the partially hydrogenated intermediates. In runs 1 and 2, performed at 50° C., the yield of the two intermediates C and D (2-amino-4-nitrotoluene and 4-amino-2-nitro-toluene) was in a ratio c_{C}/C_{D} of approximately 1.1. In comparison, the ratio was approximately 1.8 for experiments 3 and 4, performed at 80° C. Table 6 shows a summary of the steady state average concentrations ratios obtained in experiments 1 through 4.

Efficient heat management is needed in chemical reactors, particularly when performing reactions with parallel competing pathways where selectivity is temperature dependent. In such scenarios, precise temperature control can ensure uniform temperature distributions and favor the desired reaction pathway while suppressing unwanted side reactions, to maximize yields of the desired product. The structure of the MFEC reactor, featuring extensive surface areas of the highly conductive metal that makes up the microfibrous network in close contact with catalytic sites where heat is generated, provides a highly effective mechanism for dissipating and removing heat. This configuration achieves precise temperature control, allowing for the fine-tuning of selectivity in synthesis processes, which can significantly enhance product quality, yield, and cost-effectiveness.

TABLE 6
Ratios of intermediates concentrations at different operating
temperatures.

| Run | T | $\frac{{c}_{4 A 2 NT}}{{c}_{2 A 4 NT}}$ |
|---|---|---|
| 1 | 50 | 1.1811 |
| 2 | 50 | 1.0466 |
| 3 | 80 | 1.8174 |
| 4 | 80 | 1.8264 |

### Comparison to Kinetic Model

Study of liquid residence time distribution using trace pulse experiments showed that surface tension effects and capillary forces in the small domains of the microfibrous bed effectively retain the liquid within preferential flow pathways that allows the gas and liquid phases to move relatively independently, while remaining in close contact due to the proximity of adjacent micron-sized domains. This feature allows this type of reactor to handle significantly different phase velocities without causing the turbulent mixing that typically leads to high axial dispersion. The microscopic scale of the MFEC pores produced low Reynolds number flow within the bed, resulting in near-plug flow behavior.

The behavior of an adsorptive bed in a complex reaction system with consecutive reaction steps is more complex than with a simple tracer pulse experiment. Significant deviation from ideal plug flow reactor behavior was found in all measured concentrations in runs 1 through 10, as shown in Table 5, when compared to the concentration profiles predicted by the kinetic model developed through batch experiments.

This observed deviation may be a result of a complex and random adsorption behavior during the multiple step reaction of hydrogenation of 2,4-DNT. Reactant species may adsorb onto the catalyst particles and undergo all reactions necessary to reach the final DAT product, or they may adsorb, react once to become one of the expected intermediates and desorb again. In batch experiments like the ones carried out for the study of the kinetics of the reaction, the initial amount of DNT as well as all the intermediates may undergo this adsorption-desorption process onto the catalyst particles while being contained in the reactor vessel until full conversion has been achieved.

In a continuous flow reactor, new DNT molecules and partially hydrogenated desorbed molecules constantly flow along the catalytic bed, and they may encounter free available sites to adsorb and further react, or occupied catalytic sites in a mostly saturated bed, and may be dragged by the flowing liquid to the reactor outlet, not completing all the steps to the final product. This combinatory adsorption-desorption behavior can result in a more complicated mixture of species at the outlet of a continuous reactor, than what is expected from a plug flow model and predicted by the kinetic equations developed with batch experiments.

The experiments showed that an additional amount of axial dispersion and mixing was introduced in this reaction system due to subsequent or competitive adsorption effects, even when axial dispersion and back mixing due to turbulent flow were expected to be very low.

TABLE 7
Nitro species concentrations experimental findings

| | τ_{liq} or | c̅_̅{̅D̅N̅T̅}̅ | c̅_̅{̅2̅A̅4̅N̅T̅}̅ | c̅_̅{̅4̅A̅2̅N̅T̅}̅ | c̅_̅{̅D̅A̅T̅}̅ |
|---|---|---|---|---|---|
| Run | tₛᵢₘ [s] | [—] | [—] | [—] | [—] |
| 1 | 252 | 0.751 | 0.067 | 0.057 | 0.078 |
| 3 | 252 | 0.359 | 0.213 | 0.117 | 0.190 |
| 5 | 245 | 0.614 | 0.112 | 0.139 | 0.098 |
| 9 | 245 | 0.801 | 0.040 | 0.027 | 0.006 |

Where

$$\overline{{c}_{ι}} = {C}_{i} / {C}_{D N T}^{0} ;$$

*Note, B is unobservable

### Deactivation of the Catalyst

A rapid deactivation of the catalyst during periods of inactivity was found in subsequent experiments carried out with the same catalyst load, after a day. As shown in Table 7, a reduction in DNT conversion was observed from run 1 to 2, from 3 to 4, and 5 to 6. These pairs of experiments were performed on the same catalyst load, on the next day. The reactor was left flooded with solvent in between the two runs. This consistent reduction in DNT conversion indicated a decay in catalyst activity during the idle periods of the reactor. Comparing the decrease in catalyst activity in these pairs of experiments, and the observed steady state conversion of DNT in Run 10, performed for 8 consecutive hours, it is possible to infer that deactivation occurred mainly during the periods where the catalyst was not being used. Deactivation may be due to coking and polymerization reactions that deposit onto and poison the catalyst surface, as well as due to irreversible adsorption of species when the catalytic bed was not kept under reaction conditions.

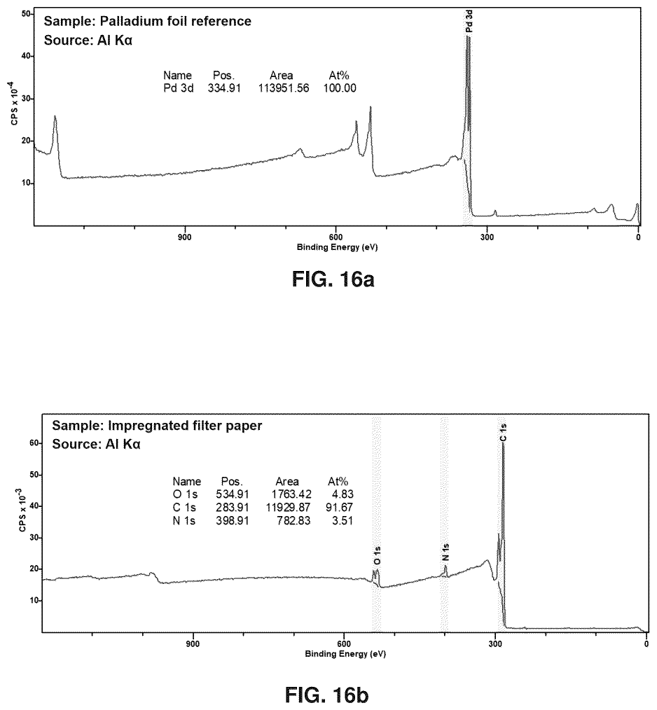

To discard the possibility of the loss of catalyst activity due to metal leaching or crystallite washing from the catalyst prepared, samples of the liquid from the reactor outlet were dried out over filter paper and analyzed with XPS, to search for the presence of any Palladium species. No Palladium was found on any of the filter paper samples (see FIG. 16 showing a surface spectrum of a paper filter sample), using a pure Palladium reference foil for comparison. FIG. 16a is a graph showing the XPS spectrum of pure Palladium foil reference. FIG. 16b is a graph showing the spectrum of filter paper impregnated with the reactor effluents during a typical experiment. The result showed that the loss of catalytic activity was most likely due to irreversible adsorption of species and coking, and not from leaching of active metal.

In-situ regeneration procedures for catalytic reactors can aid in extending catalyst life, minimize downtime, and reduce operational costs. These procedures reduce the frequency of catalyst disposal and replacement, lowering waste generation and raw material consumption, which contribute to both cost savings and environmental sustainability. To evaluate whether some of the catalytic activity could be recovered by an in-situ regeneration procedure, experiment 6 (Table 4) was performed on a previously washed reactor bed with pure methanol using an equivalent of 10 reactor volumes and then drying the reactor for 5 hours under pure hydrogen flow at 85° C., with the intention of washing away unwanted adsorbed species and reactivating the metal crystallites under a reducing environment. The results of runs 5, 6 and 7 in Table 5 showed that washing and re-reducing the catalyst helped increase the overall DNT conversion, but not to the original levels of activity as shown in the experiments where the catalyst was fresh.

### Conclusions

Heterogeneous catalytic hydrogenation of 2,4-DNT was conducted in a continuous three-phase fixed bed MFEC reactor comprising small catalyst particles entrapped in a thermally conductive porous metal microfibrous network. The reactor demonstrated effective phase contacting, residence time, and thermal management under high-throughput conditions, achieving DNT conversions of up to 60%, yielding hydrogenation products in short residence times, while efficiently managing heat to prevent runaway reactions and allowing fine-tuning of temperature-dependent selectivity toward intermediates. Rapid deactivation of the catalyst during idle periods of operation was observed, which was proved to be partially reversible by a simple procedure of washing and re-reducing. MFEC reactors can be scaled to replace existing flow chemistry technologies or batch processes, particularly for applications requiring safe and efficient high-throughput operation.

Those skilled in the art will recognize, or be able to ascertain using no more than routine experimentation, many equivalents to the specific embodiments of the invention described herein. Such equivalents are intended to be encompassed by the following claims.

### REFERENCES

Plumb, K. Continuous Processing in the Pharmaceutical Industry. Chem. Eng. Res. Des. 2005, 83 (6), 730-738. https://doi.org/10.1205/cherd.04359.
Lee, S. L.; O'Connor, T. F.; Yang, X.; Cruz, C. N.; Chatterjee, S.; Madurawe, R. D.; Moore, C. M. V.; Yu, L. X.; Woodcock, J. Modernizing Pharmaceutical Manufacturing: From Batch to Continuous Production. J. Pharm. Innov. 2015, 10 (3), 191-199. https://doi.org/10.1007/s12247-015-9215-8.
Bogdan, A. R.; Dombrowski, A. W. Emerging Trends in Flow Chemistry and Applications to the Pharmaceutical Industry. J. Med. Chem. 2019, 62 (14), 6422-6468. https://doi.org/10.1021/acs.jmedchem.8b01760.
Burange, A. S.; Osman, S. M.; Luque, R. Understanding Flow Chemistry for the Production of Active Pharmaceutical Ingredients. iScience 2022, 25 (3), 103892. https://doi.org/10.1016/j.isci.2022.103892.
Baumann, M.; Moody, T. S.; Smyth, M.; Wharry, S. A Perspective on Continuous Flow Chemistry in the Pharmaceutical Industry. Org. Process Res. Dev. 2020, 24 (10), 1802-1813. https://doi.org/10.1021/acs.oprd.9b00524.
Chen, B.; Dingerdissen, U.; Krauter, J. G. E.; Lansink Rotgerink, H. G. J.; Möbus, K.; Ostgard, D. J.; Panster, P.; Riermeier, T. H.; Seebald, S.; Tacke, T.; Trauthwein, H. New Developments in Hydrogenation Catalysis Particularly in Synthesis of Fine and Intermediate Chemicals. Appl. Catal. Gen. 2005, 280 (1), 17-46. https://doi.org/10.1016/j.apcata.2004.08.025.
Cavani, F.; Trifirò, F. Some Innovative Aspects in the Production of Monomers via Catalyzed Oxidation Processes. Appl. Catal. Gen. 1992, 88 (2), 115-135. https://doi.org/10.1016/0926-860X(92)80210-4.
Fine Chemicals through Heterogenous Catalysis; Sheldon, R. A., Bekkum, H. van, Eds.; Wiley-VCH: Weinheim; New York, 2001.
Jones, M. D. Heterogeneous Initiators for Sustainable Polymerization Processes. In Heterogenized Homogeneous Catalysts for Fine Chemicals Production; Barbaro, P., Liguori, F., Eds.; Catalysis by Metal Complexes; Springer Netherlands: Dordrecht, 2010; Vol. 33, pp 385-412. https://doi.org/10.1007/978-90-481-3696-4_11.
Duduković, M. P.; Larachi, F.; Mills, P. L. Multiphase Catalytic Reactors: A Perspective on Current Knowledge and Future Trends. Catal. Rev. 2002, 44 (1), 123-246. https://doi.org/10.1081/CR-120001460.
Al-Dahhan, M. H.; Dudukovic', M. P. Pressure Drop and Liquid Holdup in High Pressure Trickle-Bed Reactors. Chem. Eng. Sci. 1994, 49 (24), 5681-5698. https://doi.org/10.1016/0009-2509(94)00315-7.
Liu, X.; Ünal, B.; Jensen, K. F. Heterogeneous Catalysis with Continuous Flow Microreactors. Catal. Sci. Technol. 2012, 2 (10), 2134. https://doi.org/10.1039/c2cy20260c.
Jensen, K. F. Microreaction Engineering—Is Small Better? Chem. Eng. Sci. 2001, 56 (2), 293-303. https://doi.org/10.1016/S0009-2509(00)00230-X.
Gobert, S. R. L.; Kuhn, S.; Braeken, L.; Thomassen, L. C. J. Characterization of Milli- and Microflow Reactors: Mixing Efficiency and Residence Time Distribution. Org. Process Res. Dev. 2017, 21 (4), 531-542. https://doi.org/10.1021/acs.oprd.6b00359.
Masson, E.; Maciejewski, E. M.; Wheelhouse, K. M. P.; Edwards, L. J. Fixed Bed Continuous Hydrogenations in Trickle Flow Mode: A Pharmaceutical Industry Perspective. Org. Process Res. Dev. 2022, 26 (8), 2190-2223. https://doi.org/10.1021/acs.oprd.2c00034.
Kantarci, N.; Borak, F.; Ulgen, K. O. Bubble Column Reactors. Process Biochem. 2005, 40 (7), 2263-2283. https://doi.org/10.1016/j.procbio.2004.10.004.
Renken, A.; Kiwi-Minsker, L. Microstructured Catalytic Reactors. In Advances in Catalysis; Elsevier, 2010; Vol. 53, pp 47-122. https://doi.org/10.1016/S0360-0564(10)53002-5.
Van Gerven, T.; Stankiewicz, A. Structure, Energy, Synergy, Time—The Fundamentals of Process Intensification. Ind. Eng. Chem. Res. 2009, 48 (5), 2465-2474. https://doi.org/10.1021/ie801501y.
Haase, S.; Tolvanen, P.; Russo, V. Process Intensification in Chemical Reaction Engineering. Processes 2022, 10 (1), 99. https://doi.org/10.3390/pr10010099.
Plutschack, M. B.; Pieber, B.; Gilmore, K.; Seeberger, P. H. The Hitchhiker's Guide to Flow Chemistry. Chem. Rev. 2017, 117 (18), 11796-11893. https://doi.org/10.1021/acs.chemrev.7b00183.
Alsten, J. G. V; Jorgensen, M. L.; Am Ende, D. J. Hydrogenation of a Pharmaceutical Intermediate by a Continuous Stirred Tank Reactor System. Org. Process Res. Dev. 2009, 13 (3), 629-633. https://doi.org/10.1021/op800170r.
Padoin, N.; Matiazzo, T.; Riella, H. G.; Soares, C. A Perspective on the Past, the Present, and the Future of Computational Fluid Dynamics (CFD) in Flow Chemistry. J. Flow Chem. 2024, 14 (1), 239-256. https://doi.org/10.1007/s41981-024-00313-4.
Munirathinam, R.; Huskens, J.; Verboom, W. Supported Catalysis in Continuous-Flow Microreactors. Adv. Synth. Catal. 2015, 357 (6), 1093-1123. https://doi.org/10.1002/adsc.201401081.
Yang, H. Gas Phase Desulfurization Using Regenerable Microfibrous Entrapped Metal Oxide Based Sorbents for Logistic PEM Fuel Cell Applications. Doctoral dissertation, Auburn University, Auburn, Alabama, 2007.
Harris, D. K.; Cahela, D. R.; Tatarchuk, B. J. Wet Layup and Sintering of Metal-Containing Microfibrous Composites for Chemical Processing Opportunities. Compos. Part Appl. Sci. Manuf 2001, 32 (8), 1117-1126. https://doi.org/10.1016/S1359-835X(01)00059-8.
Tatarchuk, B. J.; Krishnagopalan, G.; Millard, R.; Zabasajja, J.; Kohler, D. Preparation of Mixed Fiber Composite Structures. U.S. Pat. No. 5,304,330 A, Jan. 14, 1992.
Kalluri, R. R.; Cahela, D. R.; Tatarchuk, B. J. Comparative Heterogeneous Contacting Efficiency in Fixed Bed Reactors: Opportunities for New Microstructured Systems. Appl. Catal. B Environ. 2009, 90 (3-4), 507-515. https://doi.org/10.1016/j.apcatb.2009.04.015.
Yang, H.; Cahela, D. R.; Tatarchuk, B. J. A Study of Kinetic Effects Due to Using Microfibrous Entrapped Zinc Oxide Sorbents for Hydrogen Sulfide Removal. Chem. Eng. Sci. 2008, 63 (10), 2707-2716. https://doi.org/10.1016/j.ces.2008.02.025.
Gu, Q.; Zhao, P.; Henderson, R. T.; Tatarchuk, B. J. Comparison of Packed Beds, Washcoated Monoliths, and Microfibrous Entrapped Catalysts for Ozone Decomposition at High Volumetric Flow Rates in Pressurized Systems. Ind. Eng. Chem. Res. 2016, 55 (29), 8025-8033. https://doi.org/10.1021/acs.iecr.5b04247.
Punde, S. S.; Tatarchuk, B. J. Microfibrous Entrapped Catalysts for Low Temperature CO Oxidation. MRS Proc. 2009, 1217, 1217-Y03-29. https://doi.org/10.1557/PROC-1217-Y03-29.
Sheng, M.; Yang, H.; Cahela, D. R.; Yantz, W. R.; Gonzalez, C. F.; Tatarchuk, B. J. High Conductivity Catalyst Structures for Applications in Exothermic Reactions. Appl. Catal. Gen. 2012, 445-446, 143-152. https://doi.org/10.1016/j.apcata.2012.08.012.
Cheng, X.; Yang, H.; Tatarchuk, B. J. Microfibrous Entrapped Hybrid Iron-Based Catalysts for Fischer-Tropsch Synthesis. Catal. Today 2016, 273, 62-71. https://doi.org/10.1016/j.cattod.2016.02.048.
Choudhury, H. A.; Cheng, X.; Afzal, S.; Prakash, A. V.; Tatarchuk, B. J.; Elbashir, N. O. Understanding the Deactivation Process of a Microfibrous Entrapped Cobalt Catalyst in Supercritical Fluid Fischer-Tropsch Synthesis. Catal. Today 2020, 343, 112-124. https://doi.org/10.1016/j.cattod.2019.01.031.
Wahid, S.; Cahela, D. R.; Tatarchuk, B. J. Comparison of Wash-coated Monoliths vs. Microfibrous Entrapped Catalyst Structures for Catalytic VOC Removal. AIChE J. 2014, 60 (11), 3814-3823. https://doi.org/10.1002/aic.14555.
Pollak, P. Fine Chemicals: The Industry and the Business, Second edition; Wiley: Hoboken, NJ, 2011.
Sanfilippo, D.; Rylander, P. N. Hydrogenation and Dehydrogenation. In Ullmann's Encyclopedia of Industrial Chemistry; Wiley-VCH Verlag GmbH & Co. KGaA, Ed.; Wiley-VCH Verlag GmbH & Co. KGaA: Weinheim, Germany, 2009; p a13_487.pub2. https://doi.org/10.1002/14356007.a13_487.pub2.
Fine Chemicals through Heterogenous Catalysis; Sheldon, R. A., Bekkum, H. van, Eds.; Wiley-VCH: Weinheim; New York, 2001.
Doku, G. N.; Verboom, W.; Reinhoudt, D. N.; Van Den Berg, A. On-Microchip Multiphase Chemistry—a Review of Microreactor Design Principles and Reagent Contacting Modes. Tetrahedron 2005, 61 (11), 2733-2742. https://doi.org/10.1016/j.tet.2005.01.028.
Plumb, K. Continuous Processing in the Pharmaceutical Industry. Chem. Eng. Res. Des. 2005, 83 (6), 730-738. https://doi.org/10.1205/cherd.04359.
Bogdan, A. R.; Dombrowski, A. W. Emerging Trends in Flow Chemistry and Applications to the Pharmaceutical Industry. J. Med. Chem. 2019, 62 (14), 6422-6468. https://doi.org/10.1021/acs.jmedchem.8b01760.
Plutschack, M. B.; Pieber, B.; Gilmore, K.; Seeberger, P. H. The Hitchhiker's Guide to Flow Chemistry. Chem. Rev. 2017, 117 (18), 11796-11893. https://doi.org/10.1021/acs.chemrev.7b00183.
Catalyst Separation, Recovery and Recycling: Chemistry and Process Design; Cole-Hamilton, D. J., Tooze, R. P., Eds.; Catalysis by Metal Complexes; Springer: Dordrecht, 2006.
Burange, A. S.; Osman, S. M.; Luque, R. Understanding Flow Chemistry for the Production of Active Pharmaceutical Ingredients. iScience 2022, 25 (3), 103892. https://doi.org/10.1016/j.isci.2022.103892.
Galant, O.; Diesendruck, C. E.; Spatari, S. Environmental Impact Differences of Single-Chain Nanoparticle Production by Batch and Flow Chemistry. Org. Process Res. Dev. 2024, 28 (5), 1607-1617. https://doi.org/10.1021/acs.oprd.3c00244.
Johnson, M. D.; Braden, T.; Calvin, J. R.; Campbell Brewer, A.; Cole, K. P.; Frank, S.; Kerr, M.; Kjell, D.; Kopach, M. E.; Martinelli, J. R.; May, Scott. A.; Rincon, J.; White, T. D.; Yates, M. H. The History of Flow Chemistry at Eli Lilly and Company. CHIMIA 2023, 77 (5), 319. https://doi.org/10.2533/chimia.2023.319.
Baumann, M.; Moody, T. S.; Smyth, M.; Wharry, S. A Perspective on Continuous Flow Chemistry in the Pharmaceutical Industry. Org. Process Res. Dev. 2020, 24 (10), 1802-1813. https://doi.org/10.1021/acs.oprd.9b00524.
Salehi Marzijarani, N.; Snead, D. R.; McMullen, J. P.; Levesque, F.; Weisel, M.; Varsolona, R. J.; Lam, Y; Liu, Z.; Naber, J. R. One-Step Synthesis of 2-Fluoroadenine Using Hydrogen Fluoride Pyridine in a Continuous Flow Operation. Org. Process Res. Dev. 2019, 23 (8), 1522-1528. https://doi.org/10.1021/acs.oprd.9b00178.
Amara, Z.; Poliakoff, M.; Duque, R.; Geier, D.; Francio, G.; Gordon, C. M.; Meadows, R. E.; Woodward, R.; Leitner, W. Enabling the Scale-Up of a Key Asymmetric Hydrogenation Step in the Synthesis of an API Using Continuous Flow Solid-Supported Catalysis. Org. Process Res. Dev. 2016, 20 (7), 1321-1327. https://doi.org/10.1021/acs.oprd.6b00143.
(Fuse, S.; Mifune, Y; Takahashi, T. Efficient Amide Bond Formation through a Rapid and Strong Activation of Carboxylic Acids in a Microflow Reactor. Angew. Chem. Int. Ed. 2014, 53 (3), 851-855. https://doi.org/10.1002/anie.201307987.
Kockmann, N.; Roberge, D. M. Harsh Reaction Conditions in Continuous-Flow Microreactors for Pharmaceutical Production. Chem. Eng. Technol. 2009, 32 (11), 1682-1694. https://doi.org/10.1002/ceat.200900355.
Fishwick, R. P.; Natividad, R.; Kulkarni, R.; McGuire, P. A.; Wood, J.; Winterbottom, J. M.; Stitt, E. H. Selective Hydrogenation Reactions: A Comparative Study of Monolith CDC, Stirred Tank and Trickle Bed Reactors. Catal. Today 2007, 128 (1-2), 108-114. https://doi.org/10.1016/j.cattod.2007.06.030.
Sachse, A.; Galarneau, A.; Coq, B.; Fajula, F. Monolithic Flow Microreactors Improve Fine Chemicals Synthesis. New J Chem. 2011, 35 (2), 259. https://doi.org/10.1039/c0nj00965b.
Jacquot, C.; Middelkoop, V.; Köckritz, A.; Pohar, A.; Bienert, R.; Kellici, S.; Birigiu, I.-A.; Venezia, B.; Gavriilidis, A.; Likozar, B.; Beale, A. M. 3D Printed Catalytic Reactors for Aerobic Selective Oxidation of Benzyl Alcohol into Benzaldehyde in Continuous Multiphase Flow. Sustain. Mater Technol. 2021, 30, e00329. https://doi.org/10.1016/j.susmat.2021.e00329.
Kalluri, R. R.; Cahela, D. R.; Tatarchuk, B. J. Comparative Heterogeneous Contacting Efficiency in Fixed Bed Reactors: Opportunities for New Microstructured Systems. Appl. Catal. B Environ. 2009, 90 (3-4), 507-515. https://doi.org/10.1016/j.apcatb.2009.04.015.
Harris, D. K.; Cahela, D. R.; Tatarchuk, B. J. Wet Layup and Sintering of Metal-Containing Microfibrous Composites for Chemical Processing Opportunities. Compos. Part Appl. Sci. Manuf 2001, 32 (8), 1117-1126. https://doi.org/10.1016/S1359-835X(01)00059-8.
Tatarchuk, B. J.; Krishnagopalan, G.; Millard, R.; Zabasajja, J.; Kohler, D. Preparation of Mixed Fiber Composite Structures. 5304330.
Sheng, M.; Yang, H.; Cahela, D. R.; Yantz, W. R.; Gonzalez, C. F.; Tatarchuk, B. J. High Conductivity Catalyst Structures for Applications in Exothermic Reactions. Appl. Catal. Gen. 2012, 445-446, 143-152. https://doi.org/10.1016/j.apcata.2012.08.012.
Chang, B.-K.; Lu, Y; Tatarchuk, B. J. Microfibrous Entrapment of Small Catalyst or Sorbent Particulates for High Contacting-Efficiency Removal of Trace Contaminants Including CO and H2S from Practical Reformates for PEM H2-02 Fuel Cells. Chem. Eng. J. 2006, 115 (3), 195-202. https://doi.org/10.1016/j.cej.2005.10.003.
Yang, H.; Cahela, D. R.; Tatarchuk, B. J. A Study of Kinetic Effects Due to Using Microfibrous Entrapped Zinc Oxide Sorbents for Hydrogen Sulfide Removal. Chem. Eng. Sci. 2008, 63 (10), 2707-2716. https://doi.org/10.1016/j.ces.2008.02.025.
Gu, Q.; Zhao, P.; Henderson, R. T.; Tatarchuk, B. J. Comparison of Packed Beds, Washcoated Monoliths, and Microfibrous Entrapped Catalysts for Ozone Decomposition at High Volumetric Flow Rates in Pressurized Systems. Ind. Eng. Chem. Res. 2016, 55 (29), 8025-8033. https://doi.org/10.1021/acs.iecr.5b04247.
Punde, S. S.; Tatarchuk, B. J. Microfibrous Entrapped Catalysts for Low Temperature CO Oxidation. MRS Proc. 2009, 1217, 1217-Y03-29. https://doi.org/10.1557/PROC-1217-Y03-29.
Henderson, R. T. Importance of Heat Transfer During Carbon Monoxide Oxidation. PhD. Dissertation, Auburn University, Auburn, Alabama, United States, 2015. https://etd.auburn.edu/handle/10415/4774.
Cheng, X.; Yang, H.; Tatarchuk, B. J. Microfibrous Entrapped Hybrid Iron-Based Catalysts for Fischer-Tropsch Synthesis. Catal. Today 2016, 273, 62-71. https://doi.org/10.1016/j.cattod.2016.02.048.
Choudhury, H. A.; Cheng, X.; Afzal, S.; Prakash, A. V.; Tatarchuk, B. J.; Elbashir, N. O. Understanding the Deactivation Process of a Microfibrous Entrapped Cobalt Catalyst in Supercritical Fluid Fischer-Tropsch Synthesis. Catal. Today 2020, 343, 112-124. https://doi.org/10.1016/j.cattod.2019.01.031.
Janssen, H. J.; Kruithof, A. J.; Steghuis, G. J.; Westerterp, K. R. Kinetics of the Catalytic Hydrogenation of 2,4-Dinitrotoluene. 1. Experiments, Reaction Scheme, and Catalyst Activity. Ind. Eng. Chem. Res. 1990, 29 (5), 754-766. https://doi.org/10.1021/ie00101a008.
Janssen, H. J.; Kruithof, A. J.; Steghuis, G. J.; Westerterp, K. R. Kinetics of the Catalytic Hydrogenation of 2,4-Dinitrotoluene. 2. Modeling of the Reaction Rates and Catalyst Activity. Ind. Eng. Chem. Res. 1990, 29 (9), 1822-1829. https://doi.org/10.1021/ie00105a013.
Neri, G.; Musolino, M. G.; Milone, C.; Pietropaolo, D.; Galvagno, S. Particle Size Effect in the Catalytic Hydrogenation of 2,4-Dinitrotoluene over Pd/C Catalysts. Appl. Catal. Gen. 2001, 208 (1), 307-316. https://doi.org/10.1016/50926-860X(00)00717-1.
Musolino, M. G.; Neri, G.; Milone, C.; Minicò, S.; Galvagno, S. Liquid Chromatographic Separation of Intermediates of the Catalytic Hydrogenation of 2,4-Dinitrotoluene. J Chromatogr. A 1998, 818 (1), 123-126. https://doi.org/10.1016/S0021-9673(98)00458-0.
Turpin, J. L.; Huntington, R. L. Prediction of Pressure Drop for Two-phase, Two-component Concurrent Flow in Packed Beds. AIChE J. 1967, 13 (6), 1196-1202. https://doi.org/10.1002/aic.690130630.
Sheng, M.; Gonzalez, C. F.; Yantz, W. R.; Cahela, D. R.; Yang, H.; Harris, D. R.; Tatarchuk, B. J. Micro Scale Heat Transfer Comparison between Packed Beds and Microfibrous Entrapped Catalysts. Eng. Appl. Comput. Fluid Mech. 2013, 7 (4), 471-485. https://doi.org/10.1080/19942060.2013.11015486.
Mendoza, F.; Tatarchuk, B. J. Gas-Liquid-Solid Contacting in a Continuous Flow Microfibrous Entrapped Catalytic (MFEC) Reactor. Submitted to Ind. Eng. Chem. Res. 2024.
Van Gelder, K. B.; Damhof, J. K.; Kroijenga, P. J.; Westerterp, K. R. Three-Phase Packed Bed Reactor with an Evaporating Solvent—I. Experimental: The Hydrogenation of 2,4,6-Trinitrotoluene in Methanol. Chem. Eng. Sci. 1990, 45 (10), 3159-3170. https://doi.org/10.1016/0009-2509(90)80061-I.
McKenzie, P.; Kiang, S.; Tom, J.; Rubin, A. E.; Futran, M. Can Pharmaceutical Process Development Become High Tech? AIChE J. 2006, 52 (12), 3990-3994. https://doi.org/10.1002/aic.11022.
Zhang, P.; Weeranoppanant, N.; Thomas, D. A.; Tahara, K.; Stelzer, T.; Russell, M. G.; O'Mahony, M.; Myerson, A. S.; Lin, H.; Kelly, L. P.; Jensen, K. F.; Jamison, T. F.; Dai, C.; Cui, Y.; Briggs, N.; Beingessner, R. L.; Adamo, A. Advanced Continuous Flow Platform for On-Demand Pharmaceutical Manufacturing. Chem.-Eur. J. 2018, 24 (11), 2776-2784. https://doi.org/10.1002/chem.201706004.
Schaber, S. D.; Gerogiorgis, D. I.; Ramachandran, R.; Evans, J. M. B.; Barton, P. I.; Trout, B. L. Economic Analysis of Integrated Continuous and Batch Pharmaceutical Manufacturing: A Case Study. Ind. Eng. Chem. Res. 2011, 50 (17), 10083-10092. https://doi.org/10.1021/ie2006752.
Baumann, M.; Moody, T. S.; Smyth, M.; Wharry, S. A Perspective on Continuous Flow Chemistry in the Pharmaceutical Industry. Org. Process Res. Dev. 2020, 24 (10), 1802-1813. https://doi.org/10.1021/acs.oprd.9b00524.
Kockmann, N.; Roberge, D. M. Harsh Reaction Conditions in Continuous-Flow Microreactors for Pharmaceutical Production. Chem. Eng. Technol. 2009, 32 (11), 1682-1694. https://doi.org/10.1002/ceat.200900355.
Kockmann, N.; Gottsponer, M.; Zimmermann, B.; Roberge, D. M. Enabling Continuous-Flow Chemistry in Microstructured Devices for Pharmaceutical and Fine-Chemical Production. Chem. Eur. J. 2008, 14 (25), 7470-7477. https://doi.org/10.1002/chem.200800707.
Plumb, K. Continuous Processing in the Pharmaceutical Industry. Chem. Eng. Res. Des. 2005, 83 (6), 730-738. https://doi.org/10.1205/cherd.04359.
Lee, S. L.; O'Connor, T. F.; Yang, X.; Cruz, C. N.; Chatterjee, S.; Madurawe, R. D.; Moore, C. M. V.; Yu, L. X.; Woodcock, J. Modernizing Pharmaceutical Manufacturing: From Batch to Continuous Production. J. Pharm. Innov. 2015, 10 (3), 191-199. https://doi.org/10.1007/s12247-015-9215-8.
Bogdan, A. R.; Dombrowski, A. W. Emerging Trends in Flow Chemistry and Applications to the Pharmaceutical Industry. J. Med. Chem. 2019, 62 (14), 6422-6468. https://doi.org/10.1021/acs.jmedchem.8b01760.
Burange, A. S.; Osman, S. M.; Luque, R. Understanding Flow Chemistry for the Production of Active Pharmaceutical Ingredients. iScience 2022, 25 (3), 103892. https://doi.org/10.1016/j.isci.2022.103892.
Chen, B.; Dingerdissen, U.; Krauter, J. G. E.; Lansink Rotgerink, H. G. J.; Möbus, K.; Ostgard, D. J.; Panster, P.; Riermeier, T. H.; Seebald, S.; Tacke, T.; Trauthwein, H. New Developments in Hydrogenation Catalysis Particularly in Synthesis of Fine and Intermediate Chemicals. Appl. Catal. Gen. 2005, 280 (1), 17-46. https://doi.org/10.1016/j.apcata.2004.08.025.
Cavani, F.; Trifirò, F. Some Innovative Aspects in the Production of Monomers via Catalyzed Oxidation Processes. Appl. Catal. Gen. 1992, 88 (2), 115-135. https://doi.org/10.1016/0926-860X(92)80210-4.
Fine Chemicals through Heterogenous Catalysis; Sheldon, R. A., Bekkum, H. van, Eds.; Wiley-VCH: Weinheim; New York, 2001.
Jones, M. D. Heterogeneous Initiators for Sustainable Polymerization Processes. In Heterogenized Homogeneous Catalysts for Fine Chemicals Production; Barbaro, P., Liguori, F., Eds.; Catalysis by Metal Complexes; Springer Netherlands: Dordrecht, 2010; Vol. 33, pp 385-412. https://doi.org/10.1007/978-90-481-3696-4_11.
Duduković, M. P.; Larachi, F.; Mills, P. L. Multiphase Catalytic Reactors: A Perspective on Current Knowledge and Future Trends. Catal. Rev. 2002, 44 (1), 123-246. https://doi.org/10.1081/CR-120001460.
Ho, C.-H.; Yi, J.; Wang, X. Biocatalytic Continuous Manufacturing of Diabetes Drug: Plantwide Process Modeling, Optimization, and Environmental and Economic Analysis. ACS Sustain. Chem. Eng. 2019, 7 (1), 1038-1051. https://doi.org/10.1021/acssuschemeng.8b04673.
Yang, O.; Qadan, M.; Ierapetritou, M. Economic Analysis of Batch and Continuous Biopharmaceutical Antibody Production: A Review. J. Pharm. Innov. 2020, 15 (1), 182-200. https://doi.org/10.1007/s12247-018-09370-4.
Liu, X.; Ünal, B.; Jensen, K. F. Heterogeneous Catalysis with Continuous Flow Microreactors. Catal. Sci. Technol. 2012, 2 (10), 2134. https://doi.org/10.1039/c2cy20260c.
Jensen, K. F. Microreaction Engineering—Is Small Better?Chem. Eng. Sci. 2001, 56 (2), 293-303. https://doi.org/10.1016/S0009-2509(00)00230-X.
Gobert, S. R. L.; Kuhn, S.; Braeken, L.; Thomassen, L. C. J. Characterization of Milli- and Microflow Reactors: Mixing Efficiency and Residence Time Distribution. Org. Process Res. Dev. 2017, 21 (4), 531-542. https://doi.org/10.1021/acs.oprd.6b00359.
Masson, E.; Maciejewski, E. M.; Wheelhouse, K. M. P.; Edwards, L. J. Fixed Bed Continuous Hydrogenations in Trickle Flow Mode: A Pharmaceutical Industry Perspective. Org. Process Res. Dev. 2022, 26 (8), 2190-2223. https://doi.org/10.1021/acs.oprd.2c00034.
Kantarci, N.; Borak, F.; Ulgen, K. O. Bubble Column Reactors. Process Biochem. 2005, 40 (7), 2263-2283. https://doi.org/10.1016/j.procbio.2004.10.004.
Renken, A.; Kiwi-Minsker, L. Microstructured Catalytic Reactors. In Advances in Catalysis; Elsevier, 2010; Vol. 53, pp 47-122. https://doi.org/10.1016/S0360-0564(10)53002-5.

Recitation of ranges of values herein are merely intended to serve as a shorthand method of referring individually to each separate value falling within the range, unless otherwise indicated herein, and each separate value is incorporated into the specification as if it were individually recited herein.

Use of the term “about” is intended to describe values either above or below the stated value in a range of approx. +/−10%. The preceding ranges are intended to be made clear by context, and no further limitation is implied. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

The present invention may be embodied in other specific forms without departing from the spirit or essential attributes thereof and, accordingly, reference should be made to the appended claims, rather than to the foregoing specification, as indicating the scope of the invention.

We claim:

1. A reactor suitable for conducting a two-phase or a three-phase reaction, wherein the reactor comprises a vessel comprising a channel with a porous matrix therein,
wherein the porous matrix comprises pores having different diameters,
wherein, when a mixture of a liquid reactants and a gas reactant flows through the channel,
a first population of pores have sufficient diameters to hold the liquid reactant in the pores, and
a second population of pores have sufficient diameters to hold the gas reactant in the pores, and
wherein the first populations of pores have diameters that are smaller than the second population of pores.

2. The reactor of claim 1, wherein the pores in each of the first and second populations are randomly distributed throughout the matrix or are organized such that pores in the first population are next to or interspersed amongst pores in the second population and vice versa.

3. The reactor of claim 1, wherein the porous matrix has a Reynolds number (Re) less than 1500, less than 1000, less than 500, less than 100, less than 50, less than 10, less than 5, or less than 3, such as 1 or 2.

4. The reactor of claim 1, wherein the porous matrix has a void volume of up to 99.5 vol %.

5. The reactor of claim 1, wherein the porous matrix is in the form of a mesh or a foam.

6. The reactor of claim 1, wherein the porous matrix comprises a metal, a ceramic, or a polymer.

7. The reactor of claim 1, wherein the porous matrix comprises fibers, such as sinter-fused fibers or binder-fused fibers.

8. The reactor of claim 1, wherein the porous matrix comprises a compressed assemblage of fibers.

9. The reactor of claim 1, wherein the porous matrix comprises metal microfibrous media.

10. The reactor of claim 7, wherein the fibers have a diameter ranging from 2 micrometers to 20 micrometers.

11. The reactor of claim 7, wherein the volumetric loading of the fibers in the matrix is in a range from 2 vol % to 20 vol %.

12. The reactor of claim 1, wherein the reaction is a catalytic reaction, and wherein the porous matrix further comprises a catalyst entrapped therein and/or coated thereon.

13. The reactor of claim 12, wherein the volumetric loading of the catalyst in the matrix is in a range from 0.1 vol % to 60 vol %, from 1 vol % to 60 vol %, or from 10 vol % to 60 vol %.

14. The reactor of claim 12, wherein the catalyst is in the form of particulates, optionally wherein the particulates have a diameter ranging from 10 micrometers and 250 micrometers, from 25 micrometers and 250 micrometers, or from 50 micrometers and 250 micrometers.

15. The reactor of claim 1, further comprising a reactant inlet and a product outlet.

16. The reactor of claim 15, further comprising a first gas/liquid distributor connected to the reactant inlet and a second gas/liquid distributor connected to the product outlet.

17. The reactor of claim 1, further comprising one or more sensors configured to monitor the concentration of a product, flow rate of the gas, flow rate of the liquid, temperature in the reactor, and/or pressure in the reactor.

18. The reactor of claim 1, wherein the reactor is a flow chemical reactor.

19. A method for conducting a two-phase or a three-phase reaction, comprising (i) flowing a fluid reactant and a gas reactant through the reactor of claim 1, optionally wherein the gas reactant is soluble or sparing soluble in the liquid reactant.

20. The method of claim 19, wherein the fluid reactant flows at a first velocity and the gas reactant flows at a second velocity, wherein the first velocity is different from the second velocity.
